(19) United States
(12) Patent Application Publication
(10) Pub. No.: US 2024/0086859 A1
(43) Pub. Date: Mar. 14, 2024

(54) SYSTEM AND METHOD FOR OPTIMIZED RESOURCE ALLOCATION AND SCHEDULING

(71) Applicant: TimeLab LLC, Falls Church, VA (US)

(72) Inventor: Michael GILLAM, Falls Church, VA (US)

(73) Assignee: TimeLab LLC, Falls Church, VA (US)

(21) Appl. No.: 18/463,996

(22) Filed: Sep. 8, 2023

Related U.S. Application Data
(60) Provisional application No. 63/375,074, filed on Sep. 9, 2022.

(51) Int. Cl. G06Q 10/1093; G06Q 10/0631

(52) U.S. Cl. CPC G06Q 10/1097; G06Q 10/06312

(57) ABSTRACT

Approaches provide for machine-based approaches for dynamic scheduling of calendar items in digital calendar systems. The system can obtain attributes associated with calendar items, and can analyze those attributes to determine how those calendar items are to be processed, without the necessity of outside metadata or storage. Such attributes may be an activation keyword or activation attribute. The presence of the activation keyword or attribute in the calendar item metadata can indicate that the calendar item is a calendar item to be completed (e.g., a task to be completed). Attributes may also include additional attributes which affect the manner in which a calendar item is scheduled, rescheduled, or otherwise processed. Such additional attributes may include priority, deadline, time range during which the calendar item should be performed, and so forth.

### CROSS-REFERENCE TO RELATED APPLICATIONS

The present application claims priority to U.S. provisional application No. 63/375,074, filed Sep. 9, 2022, and entitled “EVENT SCHEDULER,” which is hereby incorporated herein in its entirety for all purposes.

### BACKGROUND

### Field of the Art

The present embodiments relate to systems and methods for data processing. More specifically, the present embodiments relate to systems and methods for integrating a calendar and task scheduler to enable automatic scheduling of calendar items.

### Discussion of the State of the Art

Many calendar computer systems exist that primarily keep track of a user's daily schedule. These conventional calendar systems may include fairly sophisticated tools for organizing and scheduling meetings. For example, such systems allow maintenance of a schedule of activities such as meeting appointments, teleconference schedules, vacation and business travel plans, and so forth. However, conventional systems tend to be stand-alone systems that merely keep track of scheduled items that are input by the user directly into the calendar application. In many situations, these systems may be used in conjunction with task computer systems, reminder computer systems, or other such systems. However, such integration can be cumbersome and/or difficult to implement. Accordingly, it is desirable to provide improved calendar computer systems.

### SUMMARY

Systems and methods in accordance with various embodiments of the present disclosure may overcome one or more of the aforementioned and other deficiencies experienced in conventional approaches to data processing, organization, maintenance, including detecting attributes associated with calendar items and dynamically scheduling those calendar items in digital calendar systems based on those attributes. In particular, various embodiments provide approaches for integrating a calendar and task scheduler to enable automatic scheduling of calendar items.

For example, attributes added to calendar items can be detected and analyzed by a scheduling system or other appropriate component to identify calendar items to be processed along with metadata which dictate how those calendar items are to be processed. The attributes can be directly input by a user (e.g., typed in by the user) and/or by a system receiving input from the user (e.g., the user selected an appropriate check box), or otherwise provided. The attributes can be designed to allow the calendar item to contain sufficient detail for scheduling without relying on outside metadata or additional storage. Such attributes may be an activation keyword (e.g., a keyword attribute, primary attribute, activation attribute). The presence of the activation keyword in the calendar item metadata can indicate to the system that the calendar item is a calendar item to be completed (e.g., a task to be completed). Attributes may also include additional attributes which affect the manner in which a calendar item is scheduled, rescheduled, or otherwise processed. Such additional attributes may include priority, deadline, or time range during which the calendar item should be performed, and so forth.

In one embodiment, the approaches describe the ability of the user to enter these attributes into calendar systems using the user interface of the calendar, with or without using outside websites, plug-ins, or software extensions. In an embodiment, approaches include entering the attributes into calendar items by way of an API (application programming interface) call into the remote calendar.

In various embodiments, approaches can include rescheduling of these items without the active intervention of the user. For example, if the activation keyword has not been removed from the calendar item, the calendar item can automatically be rescheduled (e.g., without intervention of the user).

Embodiments described herein enable searching for available time slots across one or more calendars that are appropriate for the attributes of the calendar item and reschedule the calendar item into the new time slot for completion of the calendar item.

In accordance with various embodiments, the system can segment a task into one or more subtasks, and the subtasks can be scheduled, rescheduled, or otherwise processed based on scheduling availability, scheduling preferences, etc.

In certain embodiments, the system described herein is configured to recognize and act upon specific keywords placed within the notes section of a calendar item (or within the metadata attributes of the calendar item standard such as iCalendar or iCal.) Through this configuration, when a user inserts such keywords, the system is enabled to autonomously facilitate the scheduling process allowing users to schedule without reliance on supplemental plugins or external web interfaces.

In various embodiments, the architecture of the system prioritizes data security and user autonomy. The system is structured such that calendar task metadata, remains localized within the user's own calendar service. Embodiments described herein effectively circumvents the need to store such data on potentially vulnerable centralized company servers, consequently bolstering the overall security and integrity of user data.

In some embodiments, the system leverages both the activation keyword and additional commands located within the notes section of a calendar item (or within the metadata attributes of the calendar item) as data sources for its operations. This approach not only obviates the need for external data storage but also provides users with a transparent view of any alterations or metadata augmentations that the system introduces to their calendar items. Through this transparency, users can maintain an informed perspective on any system-driven modifications to their scheduled tasks.

Instructions for causing a computer system to facilitate scheduling of calendar items in digital calendar systems in accordance with the present disclosure may be embodied on a computer-readable medium. For example, in accordance with an embodiment, a backend system may use machine learning-based approaches to analyze attributes added to calendar items to identify calendar items to be processed along with metadata which dictate how those calendar items are to be processed. The backend system can include the ability of the user to enter these attributes into calendar systems using the user interface of the calendar, with or without the necessity of using outside websites, plug-ins, or software extensions. The backend system can also include entering the attributes into calendar items by way of an API (application programming interface) call into the remote calendar. The backend system can include rescheduling of these items without the active intervention of the user. In an embodiment, the backend system can search for available time slots across one or more calendars that are appropriate for the attributes of the calendar item and reschedule the calendar item into the new time slot for completion of the calendar item. The backend system can segment a task into one or more subtasks, and the subtasks can be scheduled, rescheduled, or otherwise processed based on scheduling availability, user scheduling preferences, etc.

In some aspects, the techniques described herein relate to a computing system for scheduling calendar items associated with a digital calendaring system, including: a computing device processor; and a memory device including instructions that, when executed by the computing device processor, enables the computing system to: receive a calendar item associated with a user account, wherein the calendar item represents one of a scheduled task, event, or appointment within the digital calendaring system; analyze the calendar item to identify an activation attribute, the calendar item including metadata corresponding to the activation attribute, wherein the activation attribute imposes a constraint on a manner of completion of the calendar item; assign the calendar item into a first calendar slot, wherein the first calendar slot represents a predefined time period for completion of the calendar item within the digital calendaring system; determine whether the calendar item was completed within the first calendar slot; determine a second calendar slot when the calendar item is uncompleted, the second calendar slot being temporally posterior to the first calendar slot; and assign the calendar item to the second calendar slot.

In some aspects, the techniques described herein relate to a computing system, wherein the first calendar slot and second calendar slot are temporally compatible with the activation attribute, and wherein being temporally compatible with the activation attribute includes a timing of the first calendar slot and the second calendar slot satisfying at least one constraint specified by the activation attribute related to scheduling of the calendar item.

In some aspects, the techniques described herein relate to a computing system, further including: determine a third calendar slot when a second calendar item occupies the second calendar slot; assign the second calendar item to the third calendar slot; and assign the calendar item to the second calendar slot, wherein the assignments occur at substantially a same time.

In some aspects, the techniques described herein relate to a computing system, wherein the activation attribute imposes constraints on the calendar item selected from a group consisting of temporal constraints, priority constraints, and geographical constraints, wherein the temporal constraints include at least one of a deadline, start date, timebox, and recurrence, and the priority constraints include a priority score.

In some aspects, the techniques described herein relate to a computing system, wherein the instructions, when executed by the computing device processor, further enables the computing system to: assign a countdown to the calendar item when the activation attribute is a deadline, the countdown indicating a remaining time to the deadline.

In some aspects, the techniques described herein relate to a computing system, wherein the instructions, when executed by the computing device processor, further enable the computing system to: detect a rescheduling of the calendar item into the second calendar slot to a rescheduled time; calculate an updated countdown corresponding to the remaining time to the deadline for completion of the calendar item based on the rescheduled time; and incorporate the updated countdown into a title of the calendar item within the digital calendaring system, wherein the countdown in the title is configured to be automatically adjusted to reflect changes in the remaining time to the deadline, such that the countdown continuously displays an accurate measure of the time remaining until the deadline.

In some aspects, the techniques described herein relate to a computing system, wherein the instructions, when executed by the computing device processor, further enable the computing system to: track a time of completion of the calendar item when completed within a calendar slot; and store the tracked time of completion.

In some aspects, the techniques described herein relate to a computing system, wherein the calendar item is received via a calendaring system, the calendaring system being associated with a user account and configured to manage, store, and organize calendar items.

In some aspects, the techniques described herein relate to a computing system, wherein the instructions, when executed by the computing device processor to analyze the calendar item, further enables the computing system to: parse the calendar item to detect the activation attribute within the metadata of the calendar item, wherein parsing the calendar item includes scanning and interpreting components associated with a structure of the calendar item to identify the activation attribute as a unique identifier linking the calendar item to a set of scheduling guidelines.

In some aspects, the techniques described herein relate to a computing system, wherein the instructions, when executed by the computing device processor to assign the calendar item into the first calendar slot, further enables the computing system to: select a time period in the digital calendaring system, said time period corresponding to the predefined time period for completion of the calendar item, and associating the calendar item with the selected time period.

In some aspects, the techniques described herein relate to a computing system, wherein the instructions, when executed by the computing device processor to determine the second calendar slot for the uncompleted calendar item, further enables the computing system to: identify a subsequent available time period in the digital calendaring system that is temporally posterior to the first calendar slot, and designating said subsequent available time period as the second calendar slot for the uncompleted calendar item.

In some aspects, the techniques described herein relate to a computing system, wherein a graphical user interface component enables a user to create the calendar item by at least one of inputting a description, assigning an activation keyword, or specifying additional attributes including at least one of duration, deadline, priority level, time range, recurrence, and accompanying notes.

In some aspects, the techniques described herein relate to a computing system, wherein the instructions, when executed by the computing device processor, further enables the computing system to: compare a duration for the above]

In some aspects, the techniques described herein relate to a computer-implemented method, including: receiving a calendar item associated with a user account, wherein the calendar item represents one of a scheduled task, event, or appointment within a digital calendaring system; analyzing the calendar item to identify an activation attribute, the calendar item including metadata corresponding to the activation attribute, wherein the activation attribute imposes a constraint on a manner of completion of the calendar item; assigning the calendar item into a first calendar slot, wherein the first calendar slot represents a predefined time period for completion of the calendar item within the digital calendaring system; determining whether the calendar item was completed within the first calendar slot; determining a second calendar slot when the calendar item is uncompleted, the second calendar slot being temporally posterior to the first calendar slot; and assigning the calendar item to the second calendar slot.

In some aspects, the techniques described herein relate to a computer-implemented method, further including: determining a third calendar slot when a second calendar item occupies the second calendar slot; assigning the second calendar item to the third calendar slot; and assigning the calendar item to the second calendar slot, wherein the assignments occur at substantially a same time.

In some aspects, the techniques described herein relate to a computer-implemented method, further including: assigning a countdown to the calendar item when the activation attribute is a deadline, the countdown indicating a remaining time to the deadline.

In some aspects, the techniques described herein relate to a computer-implemented method, further including: detecting a rescheduling of the calendar item into the second calendar slot; calculating an updated countdown corresponding to the remaining time to the deadline for completion of the calendar item based on a rescheduled time; and incorporating the updated countdown into a title of the calendar item within the digital calendaring system, wherein the countdown in the title is configured to be automatically adjusted in real time to reflect changes in the remaining time to the deadline, such that the countdown continuously displays an accurate measure of a time remaining until the deadline.

In some aspects, the techniques described herein relate to a computer-implemented method, further including: parsing the calendar item to detect an activation attribute within the metadata of the calendar item, wherein parsing the calendar item includes scanning and interpreting components associated with a structure of the calendar item to identify the activation attribute as a unique identifier linking the calendar item to a set of scheduling guidelines.

In some aspects, the techniques described herein relate to a computer-implemented method, further including: comparing a duration for the above.

In some aspects, the techniques described herein relate to a non-transitory computer readable storage medium storing instructions that, when executed by at least one processor of a computing system, causes the computing system to: receive a calendar item associated with a user account, wherein the calendar item represents one of a scheduled task, event, or appointment within a digital calendaring system; analyze the calendar item to identify an activation attribute, the calendar item including metadata corresponding to the activation attribute, wherein the activation attribute imposes a constraint on a manner of completion of the calendar item; assign the calendar item into a first calendar slot, wherein the first calendar slot represents a predefined time period for completion of the calendar item within the digital calendaring system; determine whether the calendar item was completed within the first calendar slot; determine a second calendar slot when the calendar item is uncompleted, the second calendar slot being temporally posterior to the first calendar slot; and assign the calendar item to the second calendar slot.

Embodiments provide a variety of advantages in, e.g., the field of resource allocation and optimization in distributed systems. The integration of machine learning-based approaches offers a method to optimize the utilization of computing system resources such as calendaring systems, task management systems, project management systems, scheduling systems, and the like. These systems may be utilized by, for example, calendaring platforms, email platforms, project management platforms, workspace platforms, and other environments where task, project, and event management may be desired. In accordance with various embodiments, by providing a system that dynamically manages tasks, the system can more efficiently utilize resource capacity. For example, “to-do” lists, software, and functionality can become unnecessary and the calendar itself becomes the “to do” list, when calendar items are tagged with a single metadata element (e.g., an activation keyword). This can reduce idle resources, or other such inefficiencies of the resources, which can maximize resource usage and reduce cost. In another example, “reminder” functionality in software (e.g., reminder notification prompts) can become unnecessary because the scheduled and rescheduled entries of the calendar item in the calendar becomes the reminder. This can free up users, compute resources and/or redirect those users or compute resources to other tasks. User's time and attention can be freed as the user no longer has to switch attention between a list of tasks and one's calendar or expend effort to create reminders as the calendar items become the task list and the reminder.

In another embodiment, approaches improve resource allocation and optimization by applying machine learning techniques to continually adapt and optimize resource utilization. One or more trained models can be updated over at least one period of time using computer-readable information based on one or more task performance metrics to ensure optimal usage of various resources as well as optimal scheduling of tasks.

In yet another example, the architecture of the system improves data security and user autonomy within the context of at least distributed systems. By keeping calendar task metadata localized within the user's own calendar service and not relying on centralized servers, approaches enhance data security within these systems

In yet another embodiment, the system can be configured to diminish traditional scheduling complexities commonly encountered by users. By incorporating specific attributes or keywords into the notes section of a calendar item (or within the metadata attributes of the calendar item standard), the system is capable of detecting such indicators and autonomously manages the scheduling of said item. This operation serves to reduce the iterative communications typically associated with finding mutually agreeable time slots, thereby streamlining the cross-team scheduling process.

Various other functions and advantages are described and suggested below as may be provided in accordance with the various embodiments.

### BRIEF DESCRIPTION OF THE DRAWING FIGURES

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1A illustrates an example task management service in which aspects of the various embodiments can be implemented.

FIG. 1B illustrates an example environment in which aspects of the various embodiments can be implemented.

FIG. 2 illustrates components of an exemplary configuration interface system in accordance with various embodiments.

FIG. 3 illustrates components of an exemplary attribute attribution system in accordance with various embodiments.

FIG. 4 illustrates components of an exemplary calendar system in accordance with various embodiments.

FIG. 5 illustrates components of an exemplary scheduling system in accordance with various embodiments.

FIG. 6 illustrates an example model training that can be utilized in accordance with various embodiments.

FIG. 7A illustrates an example process for determining training data that can be utilized in accordance with various embodiments.

FIG. 7B illustrates an example process for training a model that can be utilized in accordance with various embodiments.

FIG. 8 illustrates an example process for event scheduling in accordance with various embodiments.

FIG. 9 illustrates an example process for dividing a calendar entry in accordance with various embodiments.

FIG. 10 illustrates an exemplary computing device that supports an embodiment of the inventive disclosure.

FIG. 11 illustrates an exemplary standalone computing system that supports an embodiment of the inventive disclosure.

FIG. 12 illustrates an embodiment of the computing architecture that supports an embodiment of the inventive disclosure.

FIG. 13 illustrates an exemplary overview of a computer system that supports an embodiment of the inventive disclosure.

### DETAILED DESCRIPTION

The inventive system and method (hereinafter sometimes referred to more simply as “system” or “method”) described herein relates to detecting attributes associated with calendar items and dynamically scheduling/rescheduling the calendar items in digital calendar systems based on the attributes.

Current approaches for scheduling calendar items within digital calendaring systems typically involve manual input and organization of tasks, events, and appointments. Users are required to manually input the details of each calendar item and manually assign them to specific time slots. This manual process can be time-consuming and prone to errors, leading to inefficient scheduling and potential conflicts between calendar items. Some existing calendaring systems may provide limited automation features, such as reminders or notifications for upcoming events. However, these systems often lack the ability to automatically analyze the attributes of calendar items and intelligently assign them to appropriate time slots based on predefined constraints. In addition, existing calendaring systems may not provide the flexibility to reschedule uncompleted calendar items. When a calendar item is not completed within its assigned time slot, users may need to manually reschedule it to a later time, which can be cumbersome and time-consuming.

Accordingly, in accordance with various embodiments, approaches described herein include detecting attributes added to calendar items which are used by a scheduling system to identify calendar items to be processed along with metadata dictating how those items are to be processed. The attributes are designed such that the calendar item itself contains enough detail to reschedule the calendar item without the necessity of outside metadata or storage required. The system and method can include the ability of the user to enter these attributes into calendar systems using the UI of the calendar (with or without the necessity of using outside websites, plug-ins, or software extensions) as an API (application programming interface) call into the calendar item, or a UI that uses such an API. The system and method can include rescheduling of these items without the active intervention of the user.

In an embodiment, a calendar item may be an item from a digital calendar, such as an iCalendar object or other calendar object. Examples of such items include, e.g., a task, an event, a project, a meeting, an appointment, a note, etc. The calendar item may be associated with metadata corresponding to an attribute, such as an activation keyword (also referred herein as a keyword attribute or primary attribute), which may be utilized by other components of the system to identify or process the item. For example, the attributes may be used to identify the calendar item as an item to be completed (e.g., a task to be completed) or rescheduled if uncompleted. The calendar item can include additional metadata corresponding to additional attributes, which can contain details that affect the way in which a calendar item is scheduled, rescheduled, or otherwise processed. For example, an attribute may indicate that its associated calendar item is urgent, must be completed by a particular deadline, must be performed at a specified time (e.g., on weekdays, on evenings, at a certain hour, etc.), within a specified time period (e.g., within 3-hour blocks), within a particular geographic location, and so forth. A calendar item that includes metadata corresponding to an attribute (e.g., an activation keyword and/or additional attribute) can be received from a dedicated application (e.g., direct input by the user) or a calendar (e.g., retrieved from a remote calendar).

In various embodiments, the system can be configured to diminish traditional scheduling complexities commonly encountered by users. By incorporating specific attributes or keywords into the notes section or metadata attributes of a calendar item, the system is capable of detecting such indicators and autonomously manages the scheduling of said item. This operation serves to reduce the iterative communications typically associated with finding mutually agreeable time slots, thereby streamlining the cross-team scheduling process.

In certain embodiments, the system described herein is configured to recognize and act upon specific keywords placed within the notes section or metadata attributes of a calendar item. Through this configuration, when a user inserts such keywords, the system is enabled to autonomously facilitate the scheduling process, negating the necessity for users to rely on supplemental plugins or external web interfaces.

In various embodiments, the architecture of the system prioritizes data security and user autonomy. The system is structured such that calendar task metadata remains localized within the user's own calendar service. Embodiments described herein effectively circumvents the need to store such data on potentially vulnerable centralized company servers, consequently bolstering the overall security and integrity of user data.

In some embodiments, the system leverages both the activation keyword and additional commands located within the notes section or metadata attributes of a calendar item as data sources for its operations. This approach not only obviates the need for external data storage but also provides users with a transparent view of any alterations or metadata augmentations that the system introduces to their calendar items. Through this transparency, users can maintain an informed perspective on any system-driven modifications to their scheduled tasks.

Once a calendar item is activated (e.g., has been assigned an activation keyword), the system can monitor the progress of the activated calendar item, such as whether it has been completed, partially completed, and so forth. When the activated calendar item remains uncompleted within the constraints of its assigned attributes (e.g., after the current date has lapsed) the system can reschedule the calendar item (e.g., lapsed calendar item) based on its attributes. For example, the activated calendar item may have lapsed because it remains uncompleted after the end of the current date or time. The system can scan the calendar and identify a next available date and/or time slot appropriate for the calendar item. The new calendar slot may be a date in the future but before the calendar item's deadline. The lapsed calendar item may be removed from its current calendar slot and reentered into the new time slot. A countdown may be associated with the calendar item and updated to reflect the updated time remaining until the deadline. In the situation where the new calendar slot (e.g., first available future slot) is occupied by a second calendar item which may also have an activation keyword assigned, the system can assess whether the second calendar item can be rescheduled to a later date or time. If so, the system scans the calendar for a second available future slot for the second calendar item. The system can instruct the remote calendar to remove the second calendar item from the first available future slot and reschedule it into the second available future slot. Meanwhile, the system can instruct the remote calendar to remove the first calendar item from its original slot (e.g., from the current date or time) and schedule it into the first available future slot (e.g., previously occupied by the second calendar item). When the calendar item is completed, the activation keyword may be removed from its metadata, and the system may cease monitoring and rescheduling of the calendar item.

### Conceptual Architecture

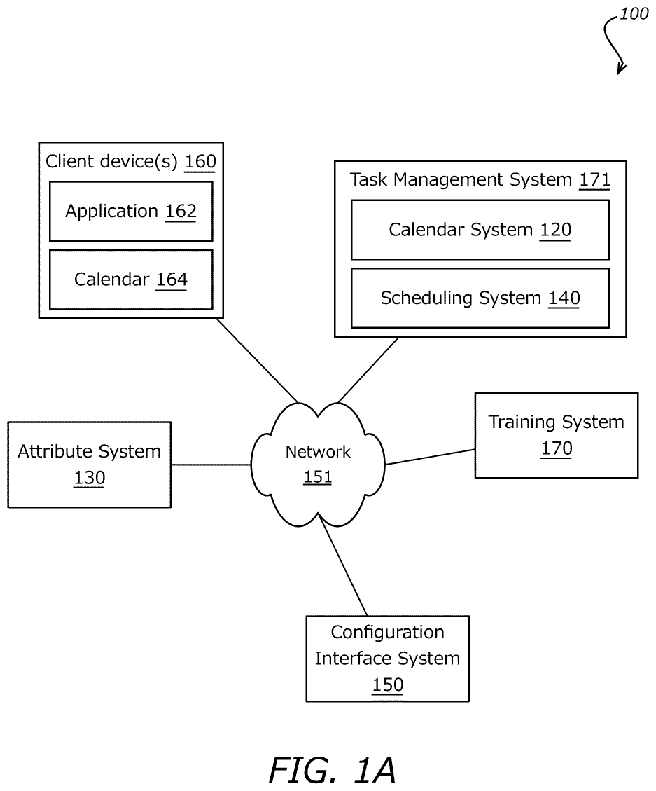

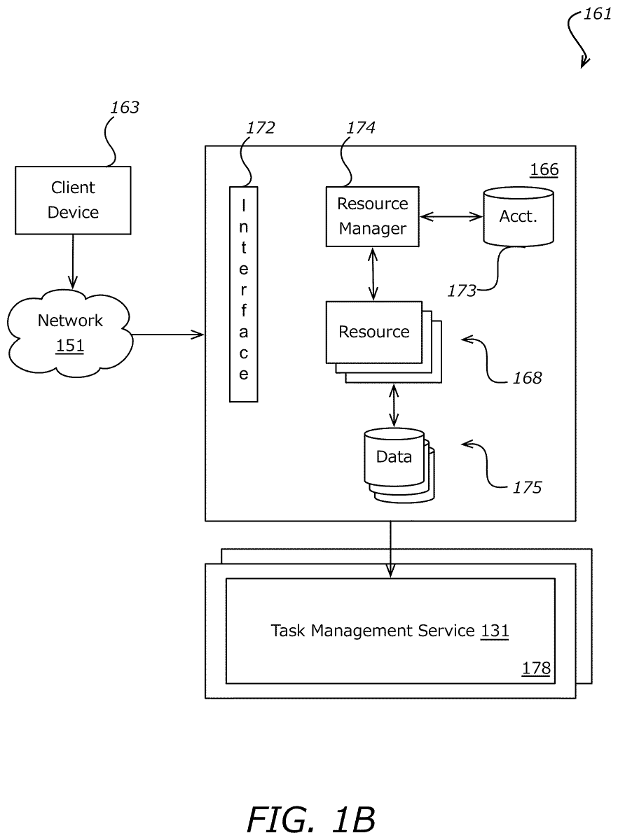

FIG. 1A illustrates an example 100 of a task management service in which aspects of the various embodiments can be implemented. It should be understood that reference numbers are carried over between figures for similar components for purposes of simplicity of explanation, but such usage should not be construed as a limitation on the various embodiments unless otherwise stated.

As shown, the environment may comprise client device(s) 160, configuration interface system 150, attribute system 130, task management system 171, and training system 170. It should be known that the various systems and components described herein are exemplary and for illustration purposes only. Client device(s) 160, configuration interface system 150, attribute system 130, task management system 171, and training system 170 may be on a single system. In another embodiment, they may be on a distributed system. The components may be reorganized or consolidated, as understood by a person of ordinary skill in the art, to perform the same tasks on one or more other servers or devices without departing from the scope of the invention. Other components may be used, as would be readily understood by a person of ordinary skill in the art, without departing from the scope of the embodiments described herein.

As described in the background, conventional data processing and calendar scheduling systems have encountered various challenges and limitations in detecting attributes associated with calendar items and dynamically scheduling those calendar items. From the complexities of integrating different task scheduling systems to the limitations in processing and prioritizing tasks and other scheduling details, existing solutions often fall short in efficiency and flexibility.

Accordingly, in accordance with various embodiments, approaches described herein enable improved data processing, organization, and maintenance. As will be further described herein, approaches enable detection of specific attributes such as activation keywords, priority, deadlines, or time ranges, that are associated with calendar items. By leveraging these attributes, the system facilitates dynamic scheduling, rescheduling, and processing of calendar items without the necessity of outside metadata or storage, user intervention, or reliance on supplemental plugins or external web interfaces. The architecture prioritizes data security, keeping calendar task metadata localized within the user's own calendar service, and offers transparency in system-driven modifications to scheduled tasks. Such approaches offer a comprehensive solution to the challenges faced by conventional systems, enhancing task scheduling capabilities.

Continuing with FIG. 1A, client device(s) 160 may comprise application 162, calendar 164, and the like. Client device(s) 160 may be in communication with configuration interface system 150, allowing a user to interface with a task management service. In particular, client device 160 (also referred to as user input device or user device) may include, generally, a computer or computing device including functionality for communicating (e.g., remotely) with configuration interface system 150. Data may be collected from client device 160, and data requests may be initiated from the client device 160. For example, client device 160 may be a server, a desktop computer, a laptop computer, tablet computer, personal digital assistant (PDA), an in- or out-of-car navigation system, a smart phone or other cellular or mobile phone, or mobile gaming device, among other suitable computing devices. Client device 160 may execute one or more client applications, such as a web browser (e.g., Microsoft Windows Internet Explorer, Mozilla Firefox, Apple Safari, Google Chrome, and Opera, etc.), or a dedicated application (also referred to herein as client application) to submit user data, to make event scheduling requests to configuration interface system 150. Client device 160 may include an interface to a calendar 164 of the user (e.g., calendar 164 is associated with an account of the user). The calendar 164 may include a digital calendar, for example, an iCalendar compatible calendar such as Apple Mac® Calendar, Google® Calendar, Microsoft Exchange Server®, among others.

A calendar item may be an item from a digital calendar, such as an iCalendar object. In particular, a calendar item may be a task, an event, a project, a meeting, an appointment, etc. The calendar item may include metadata corresponding to an attribute, such as an activation keyword (also referred herein as a keyword attribute or primary attribute), which may be utilized by other components of the system to identify the calendar item as an item to be completed (e.g., a task to be completed) or rescheduled if uncompleted. The calendar item can include additional metadata corresponding to additional attributes, which can contain details that affect the way in which a calendar item is scheduled, rescheduled, or otherwise processed. For example, an attribute may indicate that its associated calendar item is urgent, must be completed by a particular deadline, must be performed at a specified time (e.g., on weekdays, on evenings, at a certain hour, etc.), within a specified time period (e.g., within 3-hour blocks), within a particular geographic location, and so forth. A calendar item that includes metadata corresponding to an attribute (e.g., an activation keyword and/or additional attribute) can be received from the dedicated application 162 (e.g., direct input by the user) or calendar 164 (e.g., retrieved from the remote calendar).

Configuration interface system 150 is operable to receive information for the calendar item and attributes for a user account. Configuration interface system 150 may interface directly with the user through the dedicated application 162. When the calendar item is received from the dedicated application 162, configuration interface system 150 can detect an activation keyword input directly by the user. For example, the user may add an activation keyword into a newly generated calendar item through the dedicated application 162. Configuration interface system 150 may also communicate with calendar 164 to retrieve calendar items, for example, via an API request. When the calendar item is imported from calendar 164, configuration interface system 150 can attempt to recognize an activation keyword associated with the calendar item. For example, configuration interface system 150 may collect and parse the imported calendar item to scan and detect for an activation keyword that has been embedded into the metadata of the calendar item. A user may receive communications from the system through configuration interface system 150, such as notifications that a calendar item has been rescheduled, has encountered rescheduling conflicts, and so forth. Configuration interface system 150 may also communicate with third party participants associated with a calendar item, for example, by sending invitations or notifications relating to updates to the calendar item (e.g., a meeting has been rescheduled).

Attribute system 130 is configured to identify various attributes associated with a calendar item, assign the attributes to the calendar item, and pass the calendar items to task management system 171. An attribute may include an activation keyword (e.g., primary attribute or keyword attribute), which identifies the calendar item as an item to be completed (e.g., a task to be completed) or to be rescheduled if uncompleted. The calendar item may be associated with additional attributes, such as urgency, deadlines, etc. The activation keyword and additional attributes are processed by attribute system 130 and added to the metadata associated with the calendar item. In particular, attribute system 130 may activate a calendar item by assigning the activation keyword to the calendar item. For example, the attribute system 130 may directly format the metadata of a calendar item to include the activation keyword when the calendar item is received from the dedicated application 162. In another example, attribute system 130 may instruct calendar 164 to assign the attribute (e.g., keyword attribute) by sending an API request to assign the activation keyword as a metadata attribute to the calendar item. Attribute system 130 may further assign additional attributes to the activated calendar item, such as urgency, deadlines, time of day during which the calendar item must be performed, etc. Once assigned with the activation keyword, the activated calendar item may be recognized by task management system 171 as a calendar item to be completed or rescheduled if uncompleted within the constraints of its additional attributes (e.g., deadline, urgency, etc.)

Task management system 171 may comprise calendar system 120 and scheduling system 140. Calendar system 120 may receive an activated calendar item, e.g., a calendar item with an assigned activation keyword and any additional assigned attributes. Calendar system 120 schedules the activated calendar item onto the calendar 164 by, for example, by sending an API request to calendar 164 to enter the activated calendar item into an appropriate calendar slot. In an example, an activated calendar item may include metadata corresponding to a deadline attribute, wherein the calendar item must be completed by a predetermined deadline. Calendar system 120 may schedule the activated calendar item into calendar 164 for the current date (e.g., the same date the activation keyword is assigned to the calendar item). A countdown may be assigned to the activated calendar item, displaying the time remaining (e.g., number of days remaining) until the deadline.

Scheduling system 140 can track the progress of an activated calendar item, such as whether it has been completed, partially completed, and so forth. When the activated calendar item remains uncompleted within the constraints of its assigned attributes (e.g., after the current date has lapsed), scheduling system 140 can reschedule the calendar item (e.g., lapsed calendar item) based on its attributes. Embodiments of rescheduling may occur based on user specified attributes and a defined algorithm with or without the use of artificial intelligence approaches. For example, scheduling system 140 may determine that the activated calendar item has lapsed because it remains uncompleted after the end of the current date or time. Scheduling system 140 can scan calendar 164 and identify a next available date and/or time slot appropriate for the calendar item. The new calendar slot may be a date in the future but before the calendar item's deadline. Calendar system 120 can instruct calendar 164 to remove the calendar item from its current calendar slot and enter it into the new calendar slot. Scheduling system 140 may update a countdown to reflect the time remaining between the new calendar slot and the deadline. The countdown may be written into the title of the calendar item and updated at a specified cadence. In the situation where the new calendar slot (e.g., first available future slot) is occupied by a second calendar item (which may have metadata indicating it to be of lower priority), scheduling system 140 can assess whether the second calendar item can be rescheduled to a later date or time. If so, scheduling system 140 scans the calendar 164 for a second available future slot for the second calendar item. Calendar system 120 can instruct calendar 164 to remove the second calendar item from the first available future slot and reschedule it into the second available future slot. Meanwhile, calendar system 120 can instruct calendar 164 to remove the first calendar item from its original slot (e.g., from the current date or time) and schedule it into the first available future slot (e.g., previously occupied by the second calendar item or in a new slot that fits its time constraints).

Training system 170 can provide models to be used by Task management system 171, such as to optimize the rescheduling process of calendar items. When the calendar item is completed, scheduling system 140 may remove the activation keyword from the calendar item. Scheduling system 140 may collect performance metric data related to the manner of completion of the completed calendar item, which can be used by training system 170 to improve rescheduling by Task management system 171. For example, scheduling system 140 may analyze the actual duration needed to complete a calendar item, and whether the calendar item was split into periodic subtasks. Training system 170 may collect this data to improve how Task management system 171 manages future calendar items such as long-term projects that can be divided into and performed through periodic, recurring subtasks, and how the Task management system 171 determines future calendar slots into which to reschedule the calendar item.

The system may be reorganized or consolidated, as understood by a person of ordinary skill in the art, to perform the same tasks on one or more other servers or computing devices without departing from the scope of the invention.

FIG. 1B illustrates an example 161 of an environment in which aspects of the various embodiments can be implemented. In this example, a user can utilize a client device 163 to communicate across at least one network 151 to a multi-tenant resource provider environment 166. The client device 163 can include any appropriate electronic device operable to send and receive requests, messages, or other such information over an appropriate network and convey information back to a user of the device. Examples of such client devices include personal computers, tablet computers, smartphones, notebook computers, and the like.

The resource provider environment 166 can provide task management services for companies for various services. These services can include, for example, IT services, marketing services, payment services, technical support services, and human resource services, among other such services, products, and/or offerings.

The network(s) 151 can include any appropriate network, including an intranet, the Internet, a cellular network, a local area network (LAN), or any other such network or combination, and communication over the network can be enabled via wired and/or wireless connections.

The resource provider environment 166 can include any appropriate components for receiving requests and returning information or performing actions in response to those requests. As an example, the provider environment might include Web servers and/or application servers for receiving and processing requests, then returning data, Web pages, video, audio, or other such content or information in response to the request.

In various embodiments, the provider environment may include various types of resources that can be utilized by multiple users for a variety of different purposes. As used herein, computing and other electronic resources utilized in a network environment can be referred to as “network resources.” These can include, for example, servers, databases, load balancers, routers, and the like, which can perform tasks such as receiving, transmitting, and/or processing data and/or executable instructions. In at least some embodiments, all or a portion of a given resource or set of resources might be allocated to a particular user or allocated for a particular task, for at least a determined period of time. The sharing of these multi-tenant resources from a provider environment is often referred to as resource sharing, Web services, or “cloud computing,” among other such terms and depending upon the specific environment and/or implementation. In this example, the provider environment includes a plurality of resources 168 of one or more types. These types can include, for example, application servers operable to process instructions provided by a user or database servers operable to process data stored in one or more data stores 175 in response to a user request. As known for such purposes, the user can also reserve at least a portion of the data storage in a given data store. Methods for enabling a user to reserve various resources and resource instances are well known in the art, such that detailed description of the entire process, and explanation of all possible components, will not be discussed in detail herein.

In at least some embodiments, a user wanting to utilize a portion of the plurality of resources 168 can submit a request that is received to an interface layer 172 of resource provider environment 166. The interface layer can include application programming interfaces (APIs) or other exposed interfaces enabling a user to submit requests to the provider environment. The interface layer 172 in this example can also include other components as well, such as at least one Web server, routing components, load balancers, and the like. When a request to provision a resource is received to the interface layer 172, information for the request can be directed to a resource manager 174 or other such system, service, or component configured to manage user accounts 173 and information, resource provisioning and usage, and other such aspects. A resource manager 174 receiving the request can perform tasks such as to authenticate an identity of the user submitting the request, as well as to determine whether that user has an existing account with the resource provider, where the account data may be stored in at least one data store 175 in the provider environment. A user can provide any of various types of credentials in order to authenticate an identity of the user to the provider. These credentials can include, for example, a username and password pair, biometric data, a digital signature, or other such information. The provider can validate this information against information stored for the user. If the user has an account with the appropriate permissions, status, etc., the resource manager can determine whether there are adequate resources available to suit the user's request, and if so can provision the resources or otherwise grant access to the corresponding portion of those resources for use by the user for an amount specified by the request. This amount can include, for example, capacity to process a single request or perform a single task, a specified period of time, or a recurring/renewable period, among other such values. If the user does not have a valid account with the provider, the user account does not enable access to the type of resources specified in the request, or another such reason is preventing the user from obtaining access to such resources, a communication can be sent to the user to enable the user to create or modify an account, or change the resources specified in the request, among other such options.

Once the user is authenticated, the account verified, and the resources allocated, the user can utilize the allocated resource(s) for the specified capacity, amount of data transfer, period of time, or other such value. In at least some embodiments, a user might provide a session token or other such credentials with subsequent requests in order to enable those requests to be processed on that user session. The user can receive a resource identifier, specific address, or other such information that can enable the client device 163 to communicate with an allocated resource without having to communicate with the resource manager 174, at least until such time as a relevant aspect of the user account changes, the user is no longer granted access to the resource, or another such aspect changes.

The resource manager 174 (or another such system or service) in this example can also function as a virtual layer of hardware and software components that handles control functions in addition to management actions, as may include provisioning, scaling, replication, etc. The resource manager can utilize dedicated APIs in the interface layer 172, where each API can be provided to receive requests for at least one specific action to be performed with respect to the data environment, such as to provision, scale, clone, or hibernate an instance. Upon receiving a request to one of the APIs, a Web services portion of the interface layer can parse or otherwise analyze the request to determine the steps or actions needed to act on or process the call. For example, a Web service call might be received that includes a request to create a data repository.

An interface layer 172 in at least one embodiment includes a scalable set of customer-facing servers that can provide the various APIs and return the appropriate responses based on the API specifications. The interface layer also can include at least one API service layer that in one embodiment consists of stateless, replicated servers which process the externally-facing customer APIs. The interface layer can be responsible for Web service front-end features such as authenticating customers based on credentials, authorizing the customer, throttling customer requests to the API servers, validating user input, and marshalling or unmarshalling requests and responses. The API layer also can be responsible for reading and writing database configuration data to/from the administration data store, in response to the API calls. In many embodiments, the Web services layer and/or API service layer will be the only externally visible component, or the only component that is visible to, and accessible by, customers of the control service. The servers of the Web services layer can be stateless and scaled horizontally as known in the art. API servers, as well as the persistent data store, can be spread across multiple data centers in a region, for example, such that the servers are resilient to single data center failures.

A host machine 178 in at least one embodiment can host task management service 131. It should be noted that although host machine 178 is shown outside the provider environment, in accordance with various embodiments, task management service can be included in provider environment 166, while in other embodiments, one or the other can be included in the provider environment. In various embodiments, one or more host machines can be instantiated to host such systems for third parties, additional processing of preview requests, and the like. Task management service 131, as described, enables the detection of specific attributes such as activation keywords, priority, deadlines, or time ranges, that are associated with calendar items. By leveraging these attributes, task management service 131 facilitates dynamic scheduling, rescheduling, and processing of calendar items without the necessity of outside metadata or storage, user intervention, or reliance on supplemental plugins or external web interfaces. The architecture of task management service 131 prioritizes data security, keeping calendar task metadata localized within the user's own calendar service, and offers transparency in system-driven modifications to scheduled tasks.

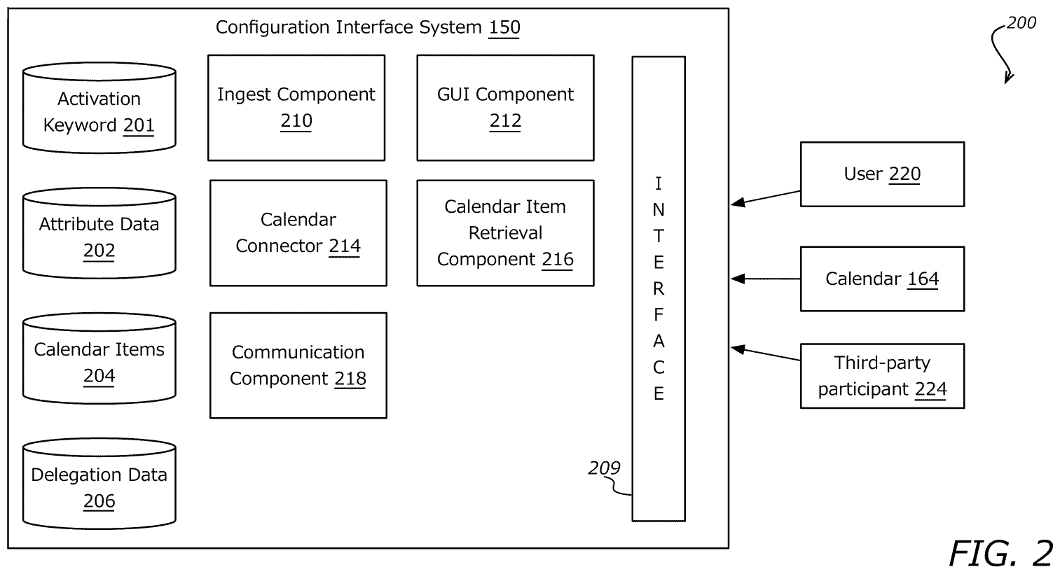

FIG. 2 illustrates example 200 comprising components of an exemplary configuration interface system in accordance with various embodiments. As described, configuration interface system 150 generally is operable to receive information for a calendar item and attributes for a user account. In this example, configuration interface system 150 may comprise interface 209, ingest component 210, GUI component 212, calendar connector 214, calendar item retrieval component 216, communication module 218, user 220, calendar 164, and third-party participant 224. Other systems and databases may be used, as would be readily understood by a person of ordinary skill in the art, without departing from the scope of the invention.

Configuration interface system 150 may also include or be in communication with one or more data stores, including, for example, activation keyword data store 201, attribute data store 202, calendar items data store 204, and delegation data store 206. It should be noted that although the data stores are shown as separate data stores, data from the data stores can be maintained across fewer or additional data stores. The data stores can be accessed by each of the various components in order to perform the functionality of the corresponding component. Other components, systems, services, etc. may access the data stores. Although configuration interface system 150 is shown as a single system, the system may be hosted on multiple server computers and/or distributed across multiple systems. Additionally, the components may be performed by any number of different computers and/or systems. Thus, the components may be separated into multiple services and/or over multiple disparate systems to perform the functionality described herein.

User account data associated with user 220 may be linked with calendar 164. In an embodiment, user account data can refer to a collection of information that uniquely identifies and authenticates a user within the system. This data may include, for example, the user's username, password, email address, contact information, preferences, access permissions, and associated calendar configurations. The user account data enables secure access to the user's personalized environment, including their digital calendar, and may facilitate interactions with other components within the system, such as task management service 131 or configuration interface system 150. Additionally, the user account data may store personalized settings, preferences, or attributes related to calendar items, enabling a tailored user experience that aligns with individual needs and requirements. Such data may be stored securely within a designated data store, subject to privacy and security protocols, ensuring confidentiality and integrity of the user's information within the system.

Calendar 164 can be a digital calendar, such as iCalendar-compatible calendars like Apple Mac® Calendar, Google® Calendar, Microsoft Exchange Server®, etc.

In an embodiment, a digital calendar can comprise a system or platform that enables users to create, manage, and share schedules, appointments, events, and reminders in a digital format. This can include support for various time zones, recurring events, notifications, and integration with other applications or devices. The digital calendar may allow for synchronization across various devices, enabling access from smartphones, tablets, computers, or other connected devices. Features can include the ability to invite participants to events, set reminders, categorize events by type or priority, and link to related documents or locations. By providing a centralized, digital representation of a schedule, it facilitates planning, collaboration, and time management in a way that is adaptable to both individual and organizational needs.

In an embodiment, calendar 164 can manage and store multiple types of calendar items, comprising digital objects like tasks, events, projects, meetings, appointments, etc. Attributes may encompass elements like activation keywords, deadlines, urgency, etc., used for identification or rescheduling of uncompleted items.

Calendar items data store 204 may function as a storage mechanism for calendar items associated with a user's calendar. The calendar items may include, for example, events, projects, meetings, and appointments. In an embodiment, calendar items may be stored either locally, e.g., within the user's system or in conjunction with the user's calendar.

In an embodiment, the storage within calendar items data store 204 may be configured to adhere to specific privacy protocols, allowing calendar details to be maintained within the user's system on client device 160 and in calendar 164. This configuration promotes privacy by minimizing the need to store detailed calendar items outside of the user's immediate control, enabling metadata to be stored in the data store 204.

In an embodiment, the architecture of calendar items data store 204 may be designed to provide real-time synchronization with the user's calendar to allow for, e.g., consistency and accuracy of calendar items across different platforms and devices, allowing for seamless access and manipulation of calendar information.

In certain embodiments, calendar items data store 204 may be equipped with functionalities for backup, version control, and auditing, enhancing the reliability and traceability of stored calendar items. The data store may also support user-defined permissions and settings, enabling collaboration with third-party participants when necessary.

Attribute data store 202 may function as a repository for managing and maintaining attribute information associated with calendar items in the user's calendar. The attribute information may encompass various predefined classifications of attributes, including but not limited to, urgency levels, deadlines, time constraints (e.g., restrictions to weekends only or weeknights only), and other user-defined attributes relevant to the scheduling and organization of calendar items.

In an embodiment, these attributes may be configured and stored locally within the user's calendar or synchronized with remote systems, allowing for consistent and real-time access to attribute data across different platforms and devices.

The architecture of attribute data store 202 may be designed with privacy and security protocols, ensuring that sensitive attribute information is contained within controlled environments, either solely on client device 160 or within the secure confines of calendar 164. This may minimize the exposure of specific attribute details outside the user's system, limiting access to metadata as required.

In certain embodiments, attribute data store 202 may incorporate functionalities for efficient categorization, search, and retrieval of attribute data, enhancing the user's ability to manage and prioritize calendar items based on specific criteria. Collaborative features may allow for shared access to attribute information when collaboration with third-party participants is necessary.

In an embodiment, attribute data store 202 may provide support for backup, version control, and auditing of attribute data, ensuring the integrity, traceability, and reliability of the stored attributes, aligned with user preferences and regulatory compliance requirements.

Activation keyword data store 201 can serve as a repository for managing an authorized list of activation keywords that are utilized within the system, specifically in identifying, prioritizing, or triggering actions related to calendar items in the user's calendar.

In an embodiment, activation keyword data store 201 can be configured to synchronize with the user's calendar and other relevant components of the system, ensuring real-time updates and consistency of activation keywords across platforms and devices.

The architecture of activation keyword data store 201 can include security and privacy considerations, with mechanisms for secure handling and restricted access to the stored activation keywords. The design allows for encryption, if needed, to provide controlled access to the stored data.

Activation keyword data store 201 can also offer functionalities for organization, search, and management of activation keywords, including features for customizing, categorizing, and filtering them.

Additionally, activation keyword data store 201 can provide backup, version control, and auditing capabilities, enhancing the reliability, traceability, and integrity of the stored activation keywords. User-defined permissions and collaboration tools can enable shared access and control over activation keywords when collaboration or third-party integration is required.

Delegation data store 206 can serve as a repository for storing details related to third-party participants 224 associated with calendar items in a user's calendar. The stored information can include, for example, contact information such as email addresses, roles, permissions, and other attributes that define the third-party participant's involvement with a specific calendar item.

In an embodiment, delegation data store 206 can be synchronized with calendar 164 and other relevant components within the system, allowing for real-time updates and maintaining consistency of third-party participant details across various platforms and devices.

The architecture of delegation data store 206 can incorporate security considerations, implementing mechanisms for secure handling and controlled access to the stored information. This design can include encryption to provide restricted access to the data.

In certain embodiments, delegation data store 206 can provide capabilities for backup, version control, and auditing, enhancing the reliability, traceability, and integrity of the stored details. User-defined permissions and collaboration tools can be implemented to enable controlled access and interaction with third-party participant information when collaboration or third-party coordination is required.

Delegation data store 206 can also include functionalities for the efficient organization, search, and management of third-party participant details, as well as features for customization and filtering.

Ingest component 210 is operable to communicate with various sources, including user 220, calendar 164, or third-party participant 224, in association with calendar items. It is designed to work with interface 209, which may comprise distinct functionalities such as a data interface and a service interface. These interfaces enable the periodic reception of data sets, requests, and other pertinent information related to calendar items, including their rescheduling and display.

In various embodiments, interface 209 may include a data interface and service interface and may be configured to periodically receive data sets, requests, and/or any other relevant information to reschedule calendar items and display such information. Interface 209 can include any appropriate components known or used to receive requests or other data from across a network, such as may include one or more application programming interfaces (APIs) or other such interfaces for receiving such requests and/or data.

Ingest component 210 can retrieve calendar items directly from the user 220 or through calendar 164. In particular, ingest component 210 can receive a calendar item associated with attributes (and delegation data, if any), process the calendar item and store it in the appropriate database.

In accordance with an embodiment, GUI component 212 may be operable to facilitate interactions with user 220 in the context of managing calendar items. This interaction may involve the creation, modification, viewing, and delegation of calendar items, among other functionalities.

For instance, GUI component 212 can provide a graphical user interface that allows user 220 to create a calendar item, such as a task. This includes enabling the user to input a description of the calendar item, assign an activation keyword, and specify additional attributes. These attributes may encompass aspects such as duration, deadline, priority level, time range, recurrence, and accompanying notes.

In an embodiment, the user may add a new calendar item through an interactive element, such as an “add your task” button. Upon selection, the user may be presented with fields or options for defining the aforementioned attributes.

The graphical user interface provided by GUI component 212 may enable the user to see all calendar items, possibly arranged in various ways. This could include sorting by priority level, chronological order by deadline, alphabetical listing, or separation by certain attributes like calendar items with and without deadlines. The user may also have the ability to mark calendar items as completed, thereby managing their status within the system.

The graphical user interface may further allow the user to delegate or assign a calendar item to a third-party participant. This process may involve receiving and associating the contact information of the third-party participant with the calendar item, enabling invitations or notifications related to the calendar item to be sent to the third-party participant. For example, the third-party participant might be invited to add the calendar item to their own calendar account.

In various embodiments, GUI component 212 functions as a versatile interface for user 220, enabling a wide range of interactions with calendar items within the system. It facilitates not only the creation and modification of these items but also provides comprehensive viewing and management capabilities. The GUI component 212 acts in conjunction with other components described in this application to deliver a cohesive user experience.

In accordance with an example use, a user may interact with GUI component 212 to create a new calendar item, specify its attributes, and activate it with a chosen keyword. The user may then utilize various sorting and filtering options to view this item in context with others, make subsequent modifications as needed, or delegate it to a third-party participant.

In an embodiment, ingest component 210 may identify the type of calendar item retrieved. For example, a calendar item may represent an event, task, meeting, project, among others. In an embodiment, the identification process may involve examining certain attributes or metadata associated with the calendar item. These could include predefined tags, keywords, or categorizations that are part of the calendar item's structure. Additionally, the system may analyze the content, format, or context of the calendar item, looking for distinctive features or patterns that correlate with a particular type. In some embodiments, the ingest component 210 might interact with other components in the system, such as attribute data store or user account data, to gather additional information that assists in type identification. Specific algorithms or rulesets could be employed to facilitate this determination, allowing for the automation of the process and ensuring consistency across various calendar items and sources. Once the type is identified, the ingest component 210 can then take appropriate actions such as routing the calendar item to the corresponding data store or triggering specific processing workflows designed for that type of calendar item. This identification not only streamlines the handling of calendar items within the system but also enhances the user's ability to organize, search, and manipulate calendar information according to their specific needs and preferences.

When retrieving a calendar item from calendar 164, configuration interface system 150 may communicate directly with calendar 164 belonging to the user account, for example, via an API request to calendar 164. In an embodiment, calendar connector 214 can identify the correct calendar associated with the user account and connect with calendar 164. For example, calendar connector 214 may provide credentials to authenticate and authorize access to the user account, and send API requests to calendar 164.

In certain embodiments, calendar connector 214 may have access to a database containing APIs related to various digital calendar accounts.

Calendar item retrieval component 216 is operable to retrieve calendar items from a calendar associated with user 220. Calendar item retrieval component 216 may import calendar items of the calendar and parse each calendar item to scan for and detect an activation keyword, for example, an activation keyword which matches an acceptable keyword attribute in activation keyword data store 201.

Communication module 218 is operable to send notifications to user 220 relating rescheduling of calendar items associated with the user's 220 account. Such notifications may include when a calendar item has been rescheduled, when a scheduling conflict arises when an attempt is made to reschedule a calendar item, and so forth.

In an embodiment, communication module 218 may send notifications and invitations to a third-party participant 224 associated with a calendar item of the user's 220 account. In an embodiment, a third-party participant may receive (or decline to receive) notifications relating to the calendar item at set intervals, regardless of how many times the calendar item has been updated for the user.

In certain embodiments, communication module 218 is configured to integrate specific communications into the calendar items within the user's calendar. This integration can occur in various forms and locations within a calendar item. The title of a calendar item can be directly modified to include information such as a countdown deadline or a warning that an item could not be scheduled. For instance, the module can insert a numerical countdown directly into the title or a specific error message reflecting the scheduling status. In the “description”, “notes”, or metadata section of a calendar item, the module can embed details about when the item was last scheduled, or information about its rank compared to other scheduled items. This might include exact timestamps or a numerical ranking system. Additionally, the communication module can operate with other data or metadata, embedding information that may or may not be visible to the end-user. This could involve integrating an internal tracking code for system-level monitoring or adding data related to synchronization and version tracking. Customized alerts and reminders can also be created, with specific messages or instructions embedded within calendar items. This functionality may involve configuring the precise timing and content of a reminder related to a calendar item. Furthermore, the communication module can facilitate the embedding of external references, such as links to external documents or virtual meeting rooms.

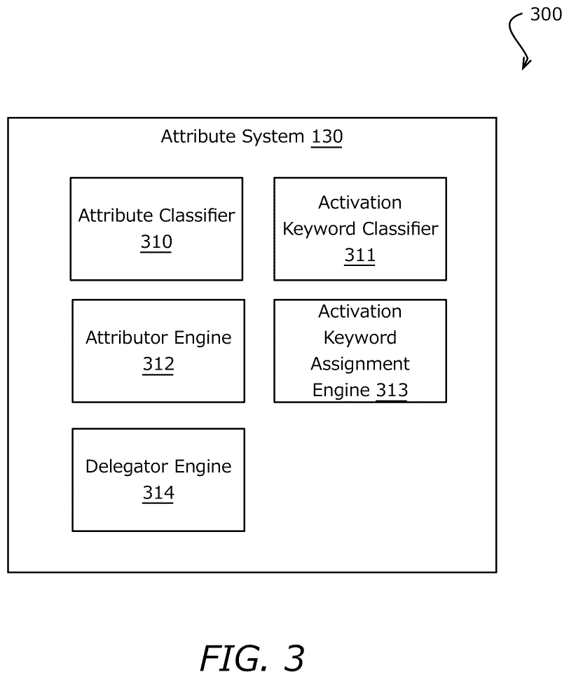

FIG. 3 illustrates example 300 comprising components of an exemplary attribute system in accordance with various embodiments. As described, attribute system 130 is operable to identify and manage various attributes associated with a calendar item and further facilitate their assignment to the calendar item. The functionalities inherent in attribute system 130 enable a systematic classification and handling of diverse aspects of calendar items. In this example, attribute system 130 may comprise attribute classifier 310, activation keyword classifier 311, attributor engine 312, activation keyword assignment engine 313, and delegator engine 314. Other systems and databases may be used, as would be readily understood by a person of ordinary skill in the art, without departing from the scope of the invention.

Attribute classifier 310 is configured to analyze and classify various attributes associated with a calendar item. In an embodiment, attributes can encompass a wide array of details, both primary and secondary, that may influence the scheduling, rescheduling, or other handling of the calendar item. In an embodiment, a primary attribute may be represented by an activation keyword that triggers specific functions or categorizations related to the calendar item.

In accordance with various embodiments, an activation keyword may be identified or distinguished through the use of specific signifiers such as special characters, alphanumeric strings, or other symbols. This allows for a unique and consistent way to recognize and process the activation keyword within the system. For example, an activation keyword might be preceded by the “@” symbol, making it easily recognizable to the system. If the user were to input “@urgent” in the notes of a calendar item, the system would recognize the string following the “@” symbol as an activation keyword, triggering specific functions or behaviors associated with the “urgent” keyword. This might include prioritizing the item, setting reminders, or other actions defined by the user or system rules. Other signifiers could also be used, such as a specific combination of alphanumeric characters or unique symbols. The choice of signifier can be system-defined or customizable according to user preferences or system requirements. The use of signifiers aids in differentiating activation keywords from regular text, minimizing the chance of misinterpretation, and enhancing the accuracy of attribute classification and processing. In various embodiments, the signifier may be standardized across the system, or there may be different signifiers for different categories or levels of activation keywords. The use of specific signifiers provides a mechanism for the system to efficiently identify, classify, and respond to activation keywords within the context of managing calendar items. It allows for streamlined automation, customization, and enhances the system's ability to adapt to system and user requirements and preferences.

In certain embodiments, additional attributes can be detected and processed, reflecting nuanced aspects of the calendar item's specifications. For example, one such additional attribute could be a “prioritization” attribute, which allows for customization of the order in which calendar items are processed or rescheduled. A user may define parameters such as “high priority” for an important client meeting, guiding the system in ranking it above other scheduled items.

In various embodiments, other additional attributes might encompass deadlines, indicating a fixed time or date by which the calendar item must be completed. An example of a deadline attribute could be setting a task with a completion date of “July 1st,” after which the system would flag the task as overdue. Timeboxing attributes may specify a particular time window or period during which the calendar item is intended to be performed, such as scheduling a recurring weekly team meeting every Monday at 9 am.

In certain embodiments, a delegation attribute may delegate a task to a third party, such as a colleague or family member. For example, the delegation attribute can be used to invite teams to meetings and have the meeting auto-scheduled by simply adding a specific keyword (e.g., “task.it”) to the notes section of the invite.

In another embodiment, a share attribute might enable sharing a task with a third party, such as sending a joint project to a colleague or sharing a grocery list with a family member. This attribute can streamline collaboration by automatically notifying the third party and allowing them to view or edit the item.

In various embodiments, attribute classifier 310 may work in conjunction with other components of the system to apply these classifications dynamically. In an embodiment, attribute classifier 310 is operable to continuously monitor and update attributes in response to changes in the calendar item's status, user input, or other contextual factors, thus maintaining the alignment and coherence of the calendar system.

Activation keyword classifier 311 is operable to detect, classify, and process primary attributes, referred to as activation keywords, within calendar items. As described, activation keywords can be utilized to transform a standard calendar item into an actionable task that can be managed, monitored, rescheduled, or otherwise handled by the system.

In one embodiment, an activation keyword can be a predetermined or user-defined keyword that, when assigned to a calendar item, serves as a flag or identifier. This marking informs the system that the item is more than a mere scheduling note—it becomes an activated task, imbued with specific properties or requirements. The activation keyword can thus act as a bridge between a conventional calendar entry and a dynamic, responsive task within the system.

Activation keyword classifier 311 can operate in various ways to detect and utilize activation keywords. In an embodiment, it may receive a calendar item from calendar 164, then parse the item's content, including any metadata, to detect the presence of an activation keyword. This parsing process may include searching, pattern matching, or other methods suitable for accurate keyword detection.

In the context of parsing to detect activation keywords, activation keyword classifier 311 employs methods to analyze the textual content of a calendar item to locate specific strings or patterns that represent predefined activation keywords. In an example, A user enters the calendar item “Meeting with clients @urgent Monday 3 p.m.” Activation keyword classifier 311 can parse this entry by scanning for special characters such as “@” and identifying the subsequent string “urgent” as the activation keyword. This triggers a function within the system that marks the calendar item with high urgency, thus influencing how it is scheduled or rescheduled. In another example, if a user creates a calendar item “Project deadline #task_it June 1st,” the activation keyword classifier 311 might recognize the string following the “#” symbol as an activation keyword. In this case, “task_it” is parsed to initiate a series of actions, such as monitoring the task until its completion and sending reminders leading up to the deadline. In yet another example, when a user inputs “Doctor appointment *priority_high* next Wednesday,” the system may be configured to search for text enclosed within asterisks as activation keywords. Parsing the phrase “priority_high” informs the system to prioritize this appointment above other scheduled items, possibly by altering its position in the user's calendar. In another example, if a user creates a calendar item with the word “task.it” in the notes section or other appropriate activation keyword, the activation keyword “task.it” triggers the system to recognize the item as a task. Additional parameters can be optionally added to change the behavior of the system as previously described (e.g. “task.it DUE in 5 days”).

In another embodiment, activation keyword classifier 311 can interact directly with the user, receiving both an activation keyword and a calendar item as input. This interactive mode allows for more tailored and user-centric task creation. For example, a user may create a calendar item for a meeting and specify an activation keyword indicating that the item is a critical task requiring ongoing monitoring and potential rescheduling if uncompleted. Upon receipt of this input, activation keyword classifier 311 validates the provided keyword, ensuring that it conforms to acceptable formats or rules.

In certain embodiments, activation keyword classifier 311 may include functionalities to support various keyword formats, including special characters, abbreviations, or other distinct markers that enhance recognition and differentiation. Such flexibility enables the system to adapt to different user preferences, industries, or workflows, ensuring broader applicability.

In an embodiment, activation keyword classifier 311 can coordinate with other components within the system, such as attributor engine 312, to synchronize and optimize the handling of activated tasks to ensure a seamless workflow, aligning the classification of activation keywords with subsequent attribute assignment and scheduling operations.

Attributor engine 312 is operable to analyze and assign additional attributes to calendar items, supplementing the primary activation keyword. These additional attributes can provide complex instructions and specifications that guide how calendar items are managed, scheduled, and processed within the system.

In an embodiment, after a primary activation keyword (for example, “task.it”) is identified and assigned to a calendar item, attributor engine 312 has the capability to further categorize and differentiate the item through the assignment of secondary or additional attributes. This multi-tiered classification allows for nuanced handling of calendar items according to specific criteria or user-defined rules. For example, attributes such as “urgency high” and/or “importance low” can be assigned to a calendar item, enabling an intelligent prioritization process. Such attributes guide the system in determining the order in which items should be scheduled, taking into consideration available time slots (e.g., calendar slots). In this manner, items with higher urgency can be allocated preferred slots, enhancing efficiency and alignment with user needs.

In another embodiment, attributor engine 312 can utilize a timeboxing attribute to specify desired scheduling parameters. A timeboxing attribute may define the optimal time windows for scheduling a task. For instance, the attributes “ON weekends only” or “ON Mondays 9 a.m.-12 p.m.” set clear constraints on when an item is to be scheduled. These details allow for fine-tuned control over scheduling, accommodating user preferences, and task requirements.

Attributor engine 312 can also be adaptable to various calendar standards, such as the iCalendar standard or other proprietary or open standards. Through the utilization of extensions or adaptors, attributor engine 312 can integrate with different calendar systems, enabling the seamless handling of metadata attributes. This integration ensures that the additional attributes are compatible with a wide range of digital calendar platforms, providing a cohesive user experience.

In certain embodiments, attributor engine 312 may work in collaboration with other system components, such as attribute classifier 310, to dynamically update or modify attributes based on real-time changes, user feedback, or system conditions. This dynamic operation ensures that attributes remain relevant and responsive to evolving needs and contexts.

Activation keyword assignment engine 313 is operable to assign and embed activation keywords within calendar items. The engine enhances the dynamic handling of calendar items by marking them with specific activation keywords, thereby transforming conventional scheduling notes into actionable tasks with distinct functionalities.

In one embodiment, an activation keyword may be defined as a specific string or phrase, such as “task.it,” that possesses intrinsic properties. Activation keyword assignment engine 313 is configured to embed the activation keyword into various fields of a calendar object that is compatible with standardized formats such as an iCalendar VCALENDAR object. This embedding may occur within the DESCRIPTION property, a custom “X-” field, or other suitable property fields of one or more VEVENTs.

In an embodiment, by assigning activation keywords to calendar items, scheduling system 140 can efficiently scan, detect, and recognize the embedded activation keyword. This enables the system to identify the marked calendar item as an entity to be monitored, managed, or possibly rescheduled if left uncompleted. The process enhances the automation and responsiveness of the scheduling system, providing tailored solutions for varying user needs or organizational workflows.

In another embodiment, activation keyword assignment engine 313 may specialize in embedding the activation keyword exclusively within the DESCRIPTION property of the VEVENT calendar component. This specificity ensures that the activation keyword is strategically positioned for optimal detection, interpretation, and handling within the system.

In another example, activation keyword assignment engine 313 may be adaptable to embed the activation keyword into a broad array of single-line or multi-line calendar properties of a digital calendar object, such as an iCalendar object. This adaptability ensures compatibility with different calendar formats and standards, extending the applicability of the engine across diverse platforms and systems.

In yet another example, activation keyword assignment engine 313 may be equipped with extensions that modify or complement existing calendar standards such as calendar 164, including the iCalendar standard, other recognized calendar standards, or even custom “X-” properties. These extensions enable the calendar items to receive metadata activation keywords, enhancing the flexibility and customization of the activation process. Such innovation allows for more tailored task creation, scheduling, and management, aligning the system with varied user preferences, industry requirements, or organizational policies.

Activation keyword assignment engine 313's functionality provides a seamless bridge between static calendar entries and dynamic, interactive tasks within the scheduling system. By innovatively utilizing activation keywords, the engine enables enhanced control, automation, and adaptability in scheduling, monitoring, and managing calendar items. The potential practical applications span various domains, including professional scheduling, personal task management, collaborative project tracking, and more. The engine contributes to a streamlined and responsive system, aligning with user needs and enhancing overall efficiency.

Activation keyword assignment engine 313 is configured to facilitate the interaction between static calendar entries and dynamic, actionable tasks within the scheduling system. By employing activation keywords in a structured manner, the engine is operable to enhance the control, automation, and adaptability of scheduling, monitoring, and managing calendar items. Such functionality can be applied across a range of use cases, including but not limited to professional scheduling, personal task management, and collaborative project tracking. The engine's capabilities contribute to a system that is optimized to meet user requirements, thereby improving overall operational efficiency.

Delegator engine 314 is configured to assign a third-party participant to a calendar item, such as a task or meeting, enhancing the collaborative aspects of the scheduling system.

In an embodiment, third-party participants can refer to individuals or entities that are externally involved in the calendar items but may not be the primary users or owners of the scheduling system. Depending on their role and the requirements of the calendar item, third-party participants may be granted various access levels, such as read-only, edit, or administrative privileges. These access levels ensure that participants can perform their assigned duties while maintaining the integrity and confidentiality of other information within the system.

In another embodiment, the scheduling system may define responsibilities of third-party participants that vary from completing entire tasks to contributing to specific portions thereof. For example, in a project development meeting, a third-party participant may be delegated only the “design discussion” portion of the meeting agenda. This assignment can encompass delegating the entire calendar item or specific portions thereof to the third-party participant for completion.

Delegator engine 314 may identify and balance workload distribution among the user and one or more third-party participants, thereby facilitating an efficient allocation of responsibilities. For example, in a software development project involving multiple tasks such as coding, testing, and documentation, delegator engine 314 can distribute these tasks among a primary user and two third-party participants. The coding might be assigned to the primary user, testing to a third-party quality assurance specialist, and documentation to a third-party technical writer. The engine intelligently considers the skill sets, availability, and workload of all involved, ensuring an equitable distribution that aligns with project timelines and goals.

Additionally, delegator engine 314 may append contact information of the third-participant to a description property of the calendar item, such as the description property or custom “X-” fields. This information can be used to prepare invitations and inform the third-party participant of the details of their participation. For instance, if the third-party participant is assigned the “testing” portion of the project, an invitation can be generated with the contact information containing a detailed description of the testing task, deadline, priority level, and any relevant activation keywords that may trigger specific functions within the scheduling system. The invitation may also include links to relevant documents, collaboration tools, or platforms that facilitate the third-party participant's role in the task.

In another embodiment, delegator engine 314 may be operable to interact with other elements of the scheduling system, such as activation keyword assignment engine 313, to ensure that delegated tasks align with system-wide rules or user preferences. This interaction can aid in identifying specific activation keywords associated with the task and processing them accordingly in the delegation process.

In yet another embodiment, delegator engine 314 may offer functionality to automatically notify third-party participants of any updates or changes related to the delegated calendar item. This automated notification could encompass adjustments to deadlines, rescheduling of meetings, or modifications to any associated attributes.

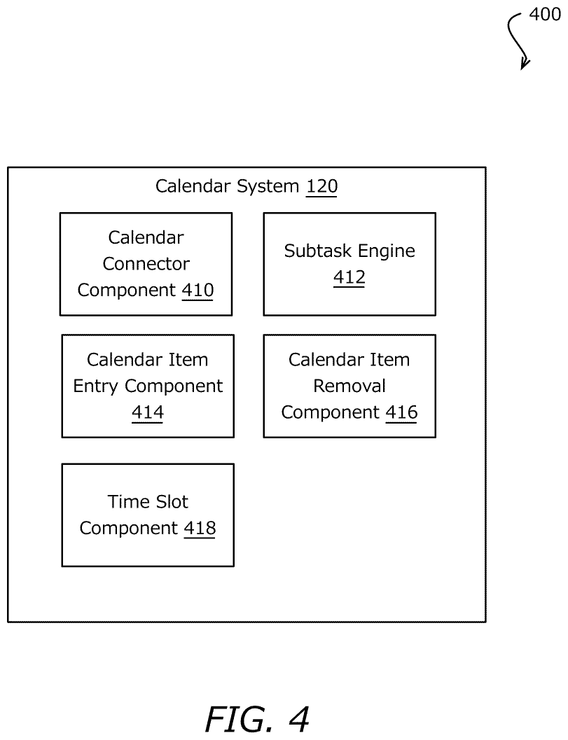

FIG. 4 illustrates example 400 comprising components of an exemplary calendar system in accordance with various embodiments. As described, calendar system 120 is operable to facilitate efficient task management, delegation, and collaboration. In this example, calendar system 120 comprises calendar connector component 410, subtask engine 412, time slot component 418, calendar item entry component 414, and calendar item removal component 416. Other systems and databases may be used, as would be readily understood by a person of ordinary skill in the art, without departing from the scope of the invention.

Calendar connector component 410 is configured to identify and establish connections to a user-specific calendar within calendar system 120. In an embodiment, calendar connector component 410 identifies a particular calendar belonging to the user, using specific identifiers, authentication tokens, or other criteria. It may verify the calendar as being connected to an account associated with the user, implementing secure authentication protocols to maintain the privacy and integrity of the user's calendar data.

Calendar connector component 410 may employ a database of APIs to facilitate connections with a plurality of user accounts associated with various virtual calendar standards, such as iCalendar, Google Calendar, Microsoft Outlook, and others.

In another embodiment, calendar connector component 410 may integrate with other components of the scheduling system, such as delegator engine 314, to synchronize the delegation of tasks or meetings with the user's calendar, ensuring accurate reflection in the user's calendar.

Further functionalities of calendar connector component 410 may include automatic synchronization of updates, conflict resolution between overlapping calendar items, or the inclusion of customized attributes and activation keywords within the calendar objects, as described in previous sections related to activation keyword assignment engine 313.

Subtask engine 412 is configured to manage the division and scheduling of larger calendar items into smaller, more manageable calendar items or subtasks within a calendar. This functionality facilitates the efficient distribution of work and assists in planning and resource allocation within a user's schedule.

In one embodiment, subtask engine 412 may analyze the characteristics of a calendar item, such as its duration, complexity, or priority. A calendar item that may be substantial in duration or complexity, such as a 40-hour project, may be determined to be divided into smaller, more manageable subtasks. Subtask engine 412 can then detect when a calendar item spans over a threshold amount of time (e.g., over a specific number of hours) and accordingly initiate the division.

In another embodiment, the division may result in a plurality of subtasks, for instance, twenty subtasks each lasting two hours. The engine may then apply algorithms or optimization methods to determine an optimal schedule for these subtasks. Various scheduling patterns may be considered, such as twenty daily 2-hour subtasks or ten weekly 4-hour subtasks (e.g., a 4-hour subtask recurring every Monday for ten weeks), depending on user preferences, project requirements, or system-defined rules.

Subtask engine 412 may also ensure that each subtask inherits appropriate attributes from the parent calendar item, such as priority level, activation keywords, or associated third-party participants. This enables consistency and alignment with the overall goals and constraints of the original calendar item.

In an embodiment, subtask engine 412 may provide functionality for dynamically adjusting subtasks in response to changes in the user's schedule or project requirements. This includes rescheduling, reassigning, or modifying subtasks as necessary to accommodate new constraints, deadlines, or changes in the availability of resources.

In an embodiment, integration with other components within the scheduling system, such as delegator engine 314 or activation keyword assignment engine 313, may also be facilitated by subtask engine 412, allowing for coordinated delegation, automation, and control across the different aspects of scheduling and task management.

Subtask engine 412 may implement various mechanisms to efficiently track and manage the subtasks created from a parent calendar item. In one embodiment, each subtask may be assigned a unique identifier (ID) or hash value. This unique identifier allows for precise identification and management of each subtask within the system, providing a robust method to track status, relationships, dependencies, and attributes specific to each subtask.

The unique identifiers may be generated using algorithms or mathematical functions that ensure uniqueness within the context of the user's calendar or even across multiple users' calendars within calendar system 120. These identifiers may also be hierarchically structured to reflect the relationship between a parent calendar item and its corresponding subtasks.

In addition to unique identifiers, subtask engine 412 may maintain a comprehensive subtask registry or database, where all relevant details of each subtask are stored. This database may include information such as the start and end times, assigned third-party participants, status (e.g., completed, in-progress, pending), associated activation keywords, and any other custom attributes defined by the user or system.

The tracking of subtasks may also be integrated with other components within the calendar system 120, such as delegator engine 314 or calendar connector component 410. Such integration ensures a seamless flow of information and enables complex functionalities like automatic synchronization with external calendars, real-time updates, and collaborative work on subtasks.

In scenarios where subtasks are altered, completed, or rescheduled, the unique identifier remains consistent, thereby maintaining the integrity of the tracking system and enabling precise reporting, analytics, and forecasting.

In certain embodiments, the system may also offer visualization tools to provide a graphical representation of subtasks, dependencies, and progress, enhancing the user's understanding and control over complex calendar items.

Calendar item entry component 414 is configured to manage the scheduling of various calendar items within a calendar, e.g., calendar 164, offering multiple paths of integration, and ensuring the proper alignment with the user's schedule and preferences. In the context of this disclosure, a calendar item may refer to a task, meeting, event, reminder, or other scheduled activities that can be represented within a calendar system.

In one embodiment, calendar item entry component 414 works in coordination with time slot component 418 to receive or determine an optimal time slot for the given calendar item. The determination of the time slot may involve analyzing the user's existing schedule, preferences, priorities, and other attributes related to the item.

Calendar item entry component 414 may facilitate direct interaction by the user 220 with the user interface of the calendar, allowing for intuitive manual scheduling without the necessity of using outside websites, plug-ins, or software extensions. This approach emphasizes the user-centric design, providing flexibility in scheduling and modifying calendar items.

In another embodiment, the scheduling process can be automated or semi-automated. For instance, calendar item entry component 414 may support API-driven interactions, enabling third-party systems, applications, or automated scheduling algorithms to send API requests to calendar 164. These requests can instruct the calendar to schedule, reschedule, or modify a calendar item in the designated time slot, ensuring seamless interoperability with various tools and platforms.

In addition to scheduling, calendar item entry component 414 may also handle the associated metadata, attributes, or linked documents related to the calendar item. This can include tracking the status, attendees, location, deadlines, priorities, and other specifications that may be relevant to the user.

In cases where the calendar item represents a complex or multi-faceted task, the entry component may integrate with subtask engine 412, ensuring that individual subtasks are appropriately scheduled and tracked within the calendar. This interplay ensures a coherent and unified representation of the task across its different stages or elements.

In certain embodiments, calendar item entry component 414 may also provide functionalities for collaboration and delegation. In connection with delegator engine 314, it may enable the assignment of tasks or meetings to third-party participants, managing notifications, permissions, and other collaborative aspects.

Calendar item removal component 416 is configured to manage the removal or relocation of calendar items within a calendar. In one embodiment, calendar item removal component 416 operates in response to the completion of a calendar item. Upon receiving confirmation that a task, event, or other item has been fulfilled, the component may remove the calendar item from the calendar, thereby reflecting the current status accurately. An API request may be utilized to facilitate this removal, targeting specific identifiers or activation keywords within the calendar item metadata.

Another aspect of the removal component's functionality addresses the deletion or removal of calendar items regardless of their completion status. This includes the ability to clear future time slots, enabling flexibility in managing upcoming commitments, meetings, or tasks. The freed time slots become available for the scheduling of other items, optimizing the allocation of time and resources.

Calendar item removal component 416 may also be involved in rescheduling. In collaboration with scheduling component 518 and calendar item entry component 414, it may assist in the removal of a calendar item from its current time slot and the subsequent entry into a new time slot. This transition can be adjusted to changes in priorities, availability, or other factors influencing the schedule, contributing to a system that can adapt to varying requirements. For example, if a user has a scheduled meeting that conflicts with an unexpected but crucial business event, the calendar item removal component 416, in conjunction with scheduling component 518 and calendar item entry component 414, may be used to reschedule the original meeting. The user can instruct the system to find a new suitable time slot. Upon identifying the conflict, the calendar item removal component 416 may remove the original meeting from its current time slot, and the calendar item entry component 414, guided by the scheduling component 518, may insert the meeting into the newly identified time slot. This rescheduling can occur without requiring the user to manually delete and recreate the calendar item, thus streamlining the rescheduling process and accommodating the unexpected change in the user's schedule.

In certain embodiments, the removal process may involve additional considerations such as maintaining historical records, managing notifications or cancellations, and handling dependencies between interconnected tasks or events. Calendar item removal component 416 can address these complexities, ensuring that removal actions are aligned with the broader context and constraints.

In addition to manual user-initiated removals, the component may support automated rules or triggers. For instance, it may automatically remove or archive calendar items based on predefined criteria, such as age, status, relevance, or other attributes defined within the system. Such automation enhances efficiency and reduces manual overhead.

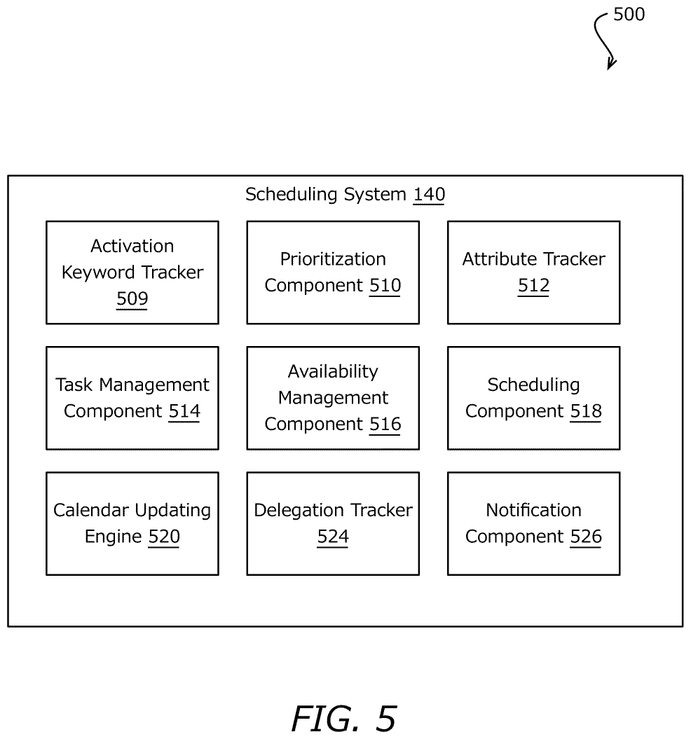

FIG. 5 illustrates example 500 comprising components of an exemplary scheduling system in accordance with an exemplary embodiment of the present invention. As described, scheduling system 140 is operable to manage, delegate, and synchronize calendar items across various users' calendars. Scheduling system 140 may comprise activation keyword tracker 509, prioritization component 510, attribute tracker 512, task management component 514, availability management component 516, scheduling component 518, calendar updating engine 520, delegation tracker 524, and notification component 526.

Activation keyword tracker 509 is configured to recognize and manage specific calendar items within the scheduling system 140, based on designated activation keywords. This component serves to identify a calendar item as an object requiring actions such as completion, monitoring, or rescheduling if uncompleted, by designating the calendar item as an activated task.

In an embodiment, activation keyword tracker 509 may parse the text or metadata of a calendar item to scan and detect an activation keyword. This keyword might match a pre-defined acceptable keyword or pattern from a database of activation keywords, signifying specific attributes, functions, or statuses within the system.

A plurality of activation keywords may be employed to designate various calendar item types or different manners of rescheduling, potentially offering a robust and flexible means of classifying, prioritizing, and managing tasks within the calendar system. For example, specific keywords may correspond to different priority levels or types of tasks such as meetings, deadlines, or project milestones.

Activation keyword tracker 509 may collaborate with attribute tracker 512 to confirm the status of the calendar item, determining whether it remains completed or uncompleted. This cooperative function may aid in providing an accurate and current view of the user's schedule, facilitating precise control and dynamic response to changing requirements.

In certain embodiments, activation keyword tracker 509 may enable automated features such as reminders or notifications based on the presence of specific activation keywords, thereby enhancing user interaction and effectiveness of task management within the scheduling system. The incorporation of user-defined activation keywords is also a possibility, allowing a personalized approach to task categorization and management.

Prioritization component 510 is configured to evaluate and assign priority to calendar items within scheduling system 140, based on specific attributes that characterize the relative importance, urgency, or timing of the tasks. This component functions to identify and interpret priority attributes (e.g., urgency, importance, deadline within a predetermined period) within a calendar item, thereby enabling intelligent scheduling and rescheduling in alignment with user needs and preferences.

In one embodiment, prioritization component 510 may detect the presence of a priority attribute within the metadata of a calendar item, particularly following an activation keyword as identified by activation keyword tracker 509. This priority attribute, or prioritization attribute, can significantly influence the scheduling decisions made by the system.

For instance, urgent calendar items, identified by metadata corresponding to an urgency attribute, may be preferentially scheduled by scheduling component 518 at the top of the calendar, such as the first item on a given calendar day. Specific examples of priority attributes may include expressions such as “urgency high,” “importance low,” and so on.

Prioritization component 510 may further calculate and assign a numerical priority score to a calendar item based on the identified priority attribute. This scoring system facilitates an organized and quantifiable approach to prioritizing tasks, assisting in determining which calendar items should be scheduled or rescheduled before others into available time slots.

In another embodiment, prioritization component 510 might enable users to manually set or adjust priority attributes through a user interface, thereby allowing a more personalized control over scheduling dynamics.

In accordance with an example use, prioritization component 510 operates as a core part of the scheduling system 140 to manage the importance and urgency of various calendar items. Initially, activation keyword tracker 509 scans and detects specific activation keywords within the calendar item metadata to identify which items should be monitored. Prioritization component 510 then extracts specific priority attributes following the activation keyword, such as ‘urgency high’ or ‘importance medium,’ and calculates a numerical priority score for each item based on these attributes. The scores may be calculated through a weighted system, giving different contributions to the overall score based on the significance of the attribute. This information is then utilized by scheduling component 518 to schedule or reschedule the calendar items into available time slots, with higher-scoring items given preference. The user may also manually adjust the priority attributes or scores through a user interface, providing personalized control over the scheduling process. Continuously, prioritization component 510 monitors the calendar items, dynamically updating priority scores based on changing conditions, user input, or system-defined rules. Integration with other components, such as task management component 514, allows the prioritization component to work in conjunction with the overall management of tasks and calendar items. Optionally, it may also generate reports or visualizations of the prioritized calendar items, offering insights into the schedule's structure. Through these operations, prioritization component 510 ensures that the user's schedule aligns with their needs, preferences, and time-sensitive obligations, representing a nuanced and adaptive approach to modern task scheduling and management.

Attribute tracker 512 is operable to monitor, log, and manage attributes associated with various calendar items. Attribute tracker 512 may actively engage with other components such as activation keyword tracker 509 and prioritization component 510 to maintain an updated log of status changes, including but not limited to changes in urgency, importance, timeboxing preferences, or other attributes as described in the present application. This tracking may involve continuous scanning and updating of the metadata associated with each calendar item.

In an embodiment, attribute tracker 512 may work with a database of predefined attributes and allow customization by user 220. For instance, a calendar item may initially be timeboxed for weekday mornings but may be later changed to weeknights only. The log maintained by attribute tracker 512 may record these changes, facilitating tracking of the item's historical attributes and enabling more intelligent and adaptable scheduling. For example, suppose a user has a recurring weekly meeting initially scheduled for Monday mornings. Over time, due to various factors such as changes in participant availability or project needs, the meeting time is adjusted several times, moving first to Tuesday afternoons, then to Thursday mornings. Attribute tracker 512 maintains a detailed log of these changes, recording each shift in time and the reasons associated with them if provided. When a request is later made to find an optimal time for a new recurring task that involves some of the same participants, attribute tracker 512 can analyze this log to identify patterns or preferences in scheduling. By recognizing that Thursday mornings have been a consistent and recent choice, the attribute tracker 512 may suggest or automatically schedule the new recurring task for Thursday mornings as well, aligning with historical preferences and maximizing the likelihood of participant availability.

Interaction with other components may further enhance the functionality of attribute tracker 512. For example, it may work with task management component 514 to align attributes with the user's overall task management strategy. Integration with availability management component 516 may ensure that changes in attributes align with the user's actual availability, thereby maintaining schedule integrity.

In another embodiment, attribute tracker 512 may detect and handle conflicting attributes within the same calendar item or among different calendar items, resolving conflicts through predefined rules or user input. For example, consider a situation where a user has a standing commitment to a team meeting every Wednesday afternoon but also sets a personal fitness goal, scheduling a gym session at the same time every Wednesday. These two calendar items represent conflicting attributes within the user's schedule. Attribute tracker 512 may detect this conflict by analyzing the scheduled time attributes of the calendar items. Upon detection, attribute tracker 512 may invoke predefined rules, such as giving priority to work-related commitments over personal ones or considering the historical attendance pattern of the user. In this case, if the team meeting is prioritized, the system may automatically reschedule the gym session to an alternative time slot. Alternatively, attribute tracker 512 may notify the user of the conflict and request input on how to resolve it, offering suggestions based on past behavior or organizational guidelines. Notification component 526 may be employed to notify the user or system administrators of such changes or conflicts, ensuring transparency and control.

In accordance with an example use, attribute tracker 512 may detect a change in a user's preference for a specific calendar item from “urgency high” to “urgency medium.” Upon detecting this change, it may update the associated log, recalculate the priority score in collaboration with prioritization component 510, and trigger a rescheduling operation by scheduling component 518. Simultaneously, attribute tracker 512 may communicate with calendar updating engine 520 to reflect these changes in the actual calendar. This operation demonstrates the role of attribute tracker 512 in maintaining an adaptive, responsive, and well-coordinated scheduling system, allowing for real-time updates and refinements to align with evolving user needs and preferences.

Task management component 514 is configured to monitor the execution of calendar items, providing real-time tracking and intelligent control over the progression of tasks within the calendar. This encompasses monitoring which calendar item is currently being performed and tracking the progress of the calendar item, including stages or milestones achieved, resources consumed, and adjustments made to the timeline. For example, task management component 514 may initiate a timer to measure the length of time a user has spent on the calendar item, comparing this duration with an anticipated completion percentage, or a predetermined schedule, forming a dynamic performance metric.

In an embodiment, task management component 514 may incorporate predictive algorithms that anticipate user behavior and requirements, adjusting the scheduling and reminders accordingly. This may include a countdown timer that indicates the time remaining for the calendar item to be completed, offering visual or auditory alerts as a deadline approaches, or suggesting modifications to enhance efficiency.

Interoperability within the system is ensured through integrations with other components. Specifically, task management component 514 may work closely with activation keyword tracker 509 to verify whether a calendar item remains uncompleted or whether it has been missed by the user. When a calendar item reaches completion, task management component 514 may communicate this status to activation keyword tracker 509, initiating the removal of the activation keyword from the calendar item metadata or altering the calendar item property to denote completion.

In accordance with an example use, suppose a user is tasked with completing a project by the end of the week. Task management component 514 may continuously assess the time spent on the project, comparing it with the projected completion timeline. If the component detects that the user is falling behind schedule, it may provide prompts or recommendations to reallocate time and resources. Concurrently, the component may dynamically adjust the scheduling of other, less urgent tasks to accommodate the priority of the project. When the project reaches completion, task management component 514 notifies other system components, updating the status, and potentially triggering further actions, such as notifications to stakeholders or initiation of subsequent phases.

Availability management component 516 is configured to dynamically manage, analyze, and optimize open time slots within the calendar. By employing intelligent algorithms, availability management component 516 may constantly scan one or multiple calendars, including those belonging to the user or other users, to identify and categorize empty slots based on diverse attributes such as duration, location, associated priorities, and user preferences.

The scanning process executed by availability management component 516 can be performed periodically at predetermined intervals, or triggered by specific events such as changes to calendar items or user requests. Additionally, availability management component 516 may reconcile discrepancies between availabilities within multiple calendars or across multiple users. This reconciliation can involve logic that takes into account factors like overlapping commitments, preferences for particular time frames or days, or constraints related to locations or resources.

In an embodiment, availability management component 516 may actively participate in the scheduling and rescheduling processes, integrating with components such as prioritization component 510 and scheduling component 518. In cases where cross-user task scheduling is required, availability management component 516 can facilitate coordination, ensuring that scheduling aligns with all involved parties' availabilities, preferences, and constraints.

In certain embodiments, availability management component 516 may leverage machine learning or other predictive technologies to forecast future availability based on historical data and patterns, thus enabling proactive scheduling and adjustments. Moreover, it may provide users with visualizations, notifications, or recommendations related to availability, enhancing user control and decision-making.

In accordance with an example use, consider a scenario where an executive seeks to schedule a series of meetings with various team members across different departments. Availability management component 516 scans the calendars of all involved individuals, identifying suitable slots that align with predefined criteria such as duration, proximity to other meetings, preferred meeting times, and room availability. If a conflict arises due to an overlapping commitment in one of the calendars, availability management component 516 can suggest alternative slots or negotiate adjustments among the conflicting items. By continuously monitoring and updating the availabilities, the component ensures that the scheduling process is smooth, accurate, and responsive to changes, contributing to the holistic and intelligent management of the scheduling ecosystem.

Scheduling component 518 is operable to manage scheduling and rescheduling of calendar items. In an embodiment, scheduling component 518 may determine a new schedule for a lapsed calendar item, working in coordination with availability management component 516 to find open time slots, while adhering to predefined criteria and avoiding conflicts. The process of identifying available slots considers factors such as urgency, importance, user preferences, and other attributes. The component also includes logic to prevent overlaps by evaluating the conditions and constraints related to rescheduling multiple calendar items.

In an embodiment, if the newly identified time slot for a rescheduled calendar item is occupied, scheduling component 518 may evaluate whether the occupying item can be moved to a different slot. This decision process may rely on the priority scores, deadlines, or other attributes of the items. For example, an item with a priority score above a threshold may be rescheduled to a sooner date, while an item without priority may be moved to a later date.

In an embodiment, scheduling component 518 may account for the interconnectedness of calendar items and handle potential impacts across the calendar. This can be managed through creating a queue, used by calendar updating engine 520, to coordinate updates to all affected items. Interactions may also occur with task management component 514 and attribute tracker 512 to obtain current status, attributes, and relationships among calendar items.

In accordance with an example use, a lapsed high-priority meeting requires rescheduling on a calendar with multiple items. Scheduling component 518 may consult the availability management component 516 to identify appropriate slots, considering the user's availability and other meeting participants. If the identified slot is occupied by a lower-priority task, the scheduling component may reschedule that task, based on priority, deadline, and other factors. Rescheduling one item may lead to further adjustments in later slots, all managed by scheduling component 518 to align with the user's needs.

Generally, calendar updating engine 520 functions to manage the modifications to calendar items within a calendar system such as calendar system 120. This may include rescheduling, marking items as completed, and other adjustments necessary to maintain an accurate and updated representation of the user's scheduling commitments.

More specifically, calendar updating engine 520 is operable to communicate (e.g., synchronous and/or asynchronous communication) with external calendaring systems, allowing for real-time interaction and modification of the calendar items. This communication can be established through different protocols or API calls, forming an interface between the components.

In this manner, calendar updating engine 520 can send instructions to calendar system 120, allowing for dynamic adjustments of time slots. This capability enables the handling of changes in schedules, such as a shift in a meeting time or a cancellation of an event. The calendar updating engine 520 may work in conjunction with scheduling component 518, leveraging predefined rules or algorithms, to determine appropriate rescheduling, taking into account factors such as priority, availability, and user preferences.

In one embodiment, calendar updating engine 520 may generate and send a queue to calendar system 120 of calendar items that need to be altered. This queue may contain information on items to be rescheduled, marked as completed, or modified in other ways. By utilizing a queue, the engine ensures that all relevant changes are made systematically, avoiding potential conflicts and overlaps.

Still in other embodiments, the calendar updating engine 520 may integrate with availability management component 516 and task management component 514, considering available slots and task progression when making modifications. This collaborative operation serves to optimize the user's schedule and align it with their preferences and priorities.

In such a case, the system may also include error handling capabilities. If a conflict or an issue is detected in the requested updates, the calendar updating engine 520 may implement predefined rules or seek user input to resolve the issue, ensuring the integrity of the scheduling data. For example, if a high-priority task needs to be moved to a slot currently occupied by a lower-priority task, the engine can make an automatic decision based on the set parameters or prompt the user for confirmation or alternative instructions. Similarly, in the context of cross-user scheduling, the calendar updating engine 520 can reconcile discrepancies between different users' calendars, facilitating collaboration and group scheduling.

In accordance with an example use, a user may need to reschedule a series of meetings due to an unexpected event. The scheduling component 518 identifies new slots, and the calendar updating engine 520 communicates with the calendar system 120 to make the necessary adjustments. Concurrently, it communicates with other components, such as the availability management component 516, to ensure that the new schedule aligns with all constraints and requirements. The synchronous communication and real-time updates provided by the calendar updating engine 520 ensure that the user's calendar reflects the latest changes, enhancing efficiency and reliability of the scheduling process.

Delegation tracker 524 is operable to monitor and manage third-party participants associated with a calendar item within a calendaring system. More specifically, the component is designed to identify the appropriate third-party participant(s) linked to a particular calendar item, and it can dynamically add or remove third-party participants as required.

In one embodiment, delegation tracker 524 may work with other components, such as the notification manager, to send and manage notifications tailored to third-party participants. The notifications can include updates, reminders, or changes related to the calendar item. For example, delegation tracker 524 can enable a user to delegate tasks to different participants, notifying them of responsibilities, due dates, or status changes.

In an embodiment, delegation tracker 524 may incorporate intelligent algorithms to prioritize third-party participants based on their relevance, role, or other criteria defined by user preferences or organization policies. In this scenario, specific permissions can be assigned to different third-party participants, determining their access level to the calendar item's details.

Still in other embodiments, delegation tracker 524 may interact with availability management component 516 to align third-party participant schedules with calendar items. In such a case, the component can adjust time slots or reschedule appointments, considering the availability of all involved participants.

In certain embodiments, delegation tracker 524 may implement security measures to safeguard third-party participant information. When a calendar item has been completed or when a third-party participant is removed from the item, the delegation tracker 524 may securely update the calendar item to remove the third-party participant's contact information, ensuring that they no longer receive notifications relating to the calendar item. This removal may be executed following specific protocols or rules to maintain data integrity and confidentiality.

In accordance with an example use, delegation tracker 524 could allow a project manager to efficiently delegate tasks within a team project, automatically sending tailored notifications to team members and updating the schedule as tasks are completed or modified. The delegation tracker would facilitate real-time coordination, keeping all parties informed and aligned, while also respecting individual privacy and security considerations.

Generally, notification component 526 is designed to facilitate the communication process related to various aspects of a calendaring system, particularly concerning calendar items and their status. It can effectively interact with users and third-party participants, providing them with updates, reminders, alerts, and other relevant information. More specifically, notification component 526 is operable to send communications when a calendar item has been rescheduled. This communication can be achieved through various means, including but not limited to emails, text messages, in-app notifications, or other forms of electronic messaging. In this manner, the component ensures that all relevant parties are informed of changes in a timely and convenient way.

In one embodiment, notification component 526 may work with scheduling component 518 to detect changes in the calendar items, such as rescheduling, cancellations, or additions. For example, if a meeting time is shifted, the notification component may promptly send an update to all attendees, minimizing confusion and potential conflicts.

In an embodiment, notification component 526 can alert users if a calendar runs out of available space beyond a specified deadline for a lapsed calendar item. In such a case, it may also provide options or suggestions for resolving the issue, such as proposing alternative time slots or allowing for manual adjustments. In other scenarios, notifications relating to scheduling conflicts or reasons why a calendar item cannot be rescheduled might be sent. Here, the notification component 526 can employ algorithms to analyze the calendar's structure, identifying conflicts, and providing detailed explanations or resolutions. This functionality can be particularly useful for complex scheduling environments with multiple participants and overlapping commitments.

As will be described in greater detail below, in some embodiments, notification component 526 may interact with delegation tracker 524 to tailor notifications for third-party participants. This interaction allows for more personalized and relevant communications, enhancing user experience and engagement. It may also add or remove other third-party participants and manage notifications accordingly. For example, in the scenario of a project meeting involving multiple departments within an organization, delegation tracker 524 could identify the relevant department heads as third-party participants. Notification component 526 would then send personalized notifications to these identified individuals, reflecting their specific roles and responsibilities related to the meeting. In such a case, the notifications could include details on the agenda, expected contributions from each department, deadlines for related tasks, and other information pertinent to the third-party participants. This integration between notification component 526 and delegation tracker 524 ensures that the notifications are not only timely but also relevant and tailored to the specific needs and interests of the recipients. Moreover, after the completion of a calendar item, delegation tracker 524 may update the status and coordinate with notification component 526 to cease or alter notifications relating to that item. This can include removing third-party participant's contact information to stop receiving notifications or adjusting the notification preferences according to user feedback.

Additionally, notification component 526 may be equipped with security features to ensure the confidentiality and integrity of the communication. This aspect is particularly crucial when sensitive information, such as private meeting details or personal contact information, is involved.

In accordance with an example use, notification component 526 could be implemented in an enterprise scheduling system. Here, it would efficiently manage communications among team members, supervisors, and other stakeholders. It would provide real-time updates on meeting changes, alert team members of deadlines, handle scheduling conflicts, and assist in rescheduling lapsed calendar items, thereby maintaining a streamlined and transparent scheduling process within the organization.

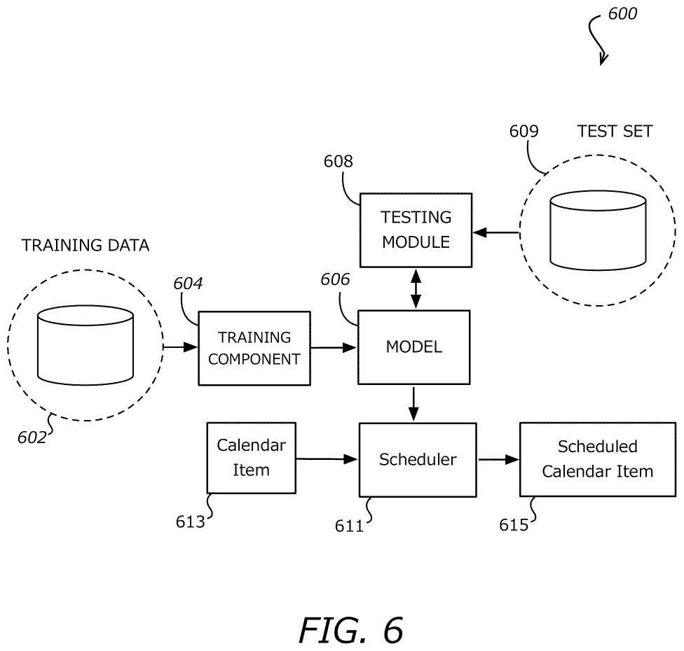

FIG. 6 illustrates an example 600 of a training system for training and utilizing a model to reschedule (or schedule) a calendar item that can be utilized in accordance with various embodiments. In this example, training system 170 may comprise training data 602, training component 604, model 606, testing module 608, test set 609, calendar item 613, reschedule 611, and rescheduled calendar item 615.

The training set 602 of calendar items is obtained, comprising performance metrics related to completed and uncompleted (e.g., lapsed) calendar items.

In an embodiment, the metrics related to calendar items can encompass various quantitative and qualitative measurements that provide insights into the scheduling patterns, user behavior, and effectiveness of the calendar management system. Potential metrics may include the completion rate, which reflects the percentage of completed calendar items against those planned or scheduled, thereby gauging the user's adherence to the schedule; lapse frequency, measuring the occurrence of uncompleted or lapsed calendar items, indicative of potential scheduling conflicts or overbooking; response time, representing the duration taken to acknowledge or respond to a new calendar item or rescheduling request, and offering insights into user responsiveness; rescheduling frequency, quantifying the number of times a calendar item has been moved or adjusted, highlighting the volatility of the schedule and areas for optimization; participant engagement metrics, for multi-participant calendar items, tracking attendance, participation rates, or feedback to assess collaboration effectiveness; location metrics, including distance between meeting locations, preferred venues, or time spent in travel to enable scheduling optimization; time metrics, encompassing various time-related measurements such as average meeting duration, time allocation across different types of activities, or distribution across projects or clients; integration metrics involving interactions with other systems, such as email response times related to calendar items, integration with task management tools, or synchronization with other participants' calendars; user satisfaction metrics through feedback or rating systems, allowing users to evaluate effectiveness, convenience, or satisfaction with the scheduling process, individual calendar items, or overall management; and automation effectiveness metrics, tracking the accuracy, acceptance rate, or efficiency of automated scheduling or rescheduling features in the system.

In an embodiment, calendar items, as referred to within the various embodiments, denote scheduled entries or appointments within a user's digital calendar. These items can represent a wide range of scheduled tasks or engagements, such as meetings, deadlines, events, reminders, or other time-bound activities. Each calendar item may contain specific details, including but not limited to the date and time, location (if applicable), participants or invitees, description of the activity or task, priority level, and associated notifications or alerts. Furthermore, calendar items may be associated with metadata, such as tags, status (e.g., completed, pending, lapsed), and linkage to related documents or files. They may be created, edited, and managed by the user, or automatically generated through integrations with other systems, such as email or project management tools. In some embodiments, calendar items may also include activation keywords or other identifiers that enable specific interactions with components described in the present invention, such as rescheduling or delegation tracking.

Training component 604 is configured to perform training on one or more models, such as neural networks or other machine learning-based algorithms. The purpose of this training is to estimate parameters for a user to complete the calendar items.

In an embodiment, parameters for a user to complete the calendar items may encompass various factors influencing the scheduling, execution, and management of activities within the calendaring system. Such parameters can include the task complexity, representing the level of difficulty or intricacy involved in completing a calendar item, which may be determined based on historical data, user feedback, or predefined categorization; estimated duration, providing a time frame required for accomplishing the calendar item, considering factors such as the nature of the task, required preparation, collaboration needs, and historical averages; priority level, defining the importance or urgency of the calendar item in relation to others, potentially influencing the scheduling or rescheduling decisions; dependency relationships, identifying linkages or sequencing requirements among different calendar items, where the completion of one item may be contingent upon another; resource requirements, detailing the human, material, or technological assets needed for the calendar item, influencing the availability, scheduling, and coordination; location considerations, including the geographical venue, travel needs, remote or on-site requirements, and associated logistical aspects; participant information, for collaborative or multi-party calendar items, encompassing details such as availability, preferences, roles, or contributions; contextual conditions, referring to external factors that might affect the execution, such as weather for outdoor activities, market conditions for business-related items, or regulatory considerations; user preferences and habits, capturing individualized traits, behaviors, or inclinations that might influence the scheduling and completion, such as preferred working hours, meeting styles, or collaboration tools; accessibility and integration with other systems, detailing the ability to synchronize, coordinate, or interact with other platforms, applications, or data sources relevant to the calendar item; feedback and historical performance metrics, utilizing past experiences, completion rates, rescheduling patterns, or user evaluations to inform future scheduling and execution; and constraints or restrictions, encompassing any limitations, rules, or boundaries that must be adhered to, such as organizational policies, contractual obligations, or legal regulations.

Training data 602 feeds performance metrics to model 606, facilitating the rescheduling of calendar items. In one embodiment, training component 604 is operable to reschedule calendar items. For instance, model 606 can learn an appropriate time slot to reschedule a lapsed calendar item and manage cascading rescheduling, considering subsequent calendar items that occupy the desired new time slots for the lapsed calendar item.

In an example, training component 604 utilizes a set of historical calendar data, including previously lapsed or rescheduled calendar items, user preferences, priority levels, time constraints, and interdependencies among different calendar items. The training component 604 feeds this rich dataset into model 606, which may be a machine learning model, such as a neural network, configured to learn the underlying patterns and relationships that govern optimal rescheduling. For instance, model 606 may learn how rescheduling a lapsed meeting at a certain time of day might lead to conflicts with other high-priority tasks, or how specific users might prefer to reschedule their appointments within certain time frames. Through an iterative training process, model 606 can identify an appropriate time slot to reschedule a lapsed calendar item, considering not only the characteristics of the lapsed item but also subsequent calendar items that may be affected by the rescheduling. When rescheduling a lapsed calendar item, model 606 considers how this change affects other items scheduled in close proximity, and it analyzes factors such as time between meetings, required preparation, travel considerations, participant availability, and adherence to organizational policies or personal preferences. Model 606 thus considers various factors to arrive at an optimal rescheduling strategy that aims to balance the completion of the lapsed calendar item with the maintenance of overall schedule integrity, efficiency, and user satisfaction. This approach may be tailored to different users, contexts, or requirements, allowing for flexibility in accommodating various scheduling needs and constraints as contemplated by various embodiments described herein.

Some embodiments may retain a portion of the training set 602 as a test set 609. This set can be used to test the trained model's ability to meet certain standards, such as a minimum threshold for rescheduling accuracy. If the trained model meets the standards, it can be incorporated into reschedule 611.

In accordance with an example use, reschedule 611 is configured to accept calendar items 613 from various sources, such as end-users, and generate rescheduling data, including rescheduled calendar items. These rescheduled items may include updated schedules for all calendar items affected by the rescheduling of the lapsed calendar item.

It should be noted that while neural networks are mentioned as an example machine learning-based model, other networks or trained models can also be used within the scope of the various embodiments. Such alternatives may include but are not limited to support vector machines (SVMs), which can be particularly effective for classification tasks; decision trees and random forests, which might be employed for hierarchical decision-making; gradient boosting models, known for optimizing predictive accuracy; k-Nearest Neighbors (k-NN) algorithms for instances where pattern recognition is vital; and linear and logistic regression models, which might be used for understanding relationships between variables. Furthermore, ensemble methods that combine the predictions from multiple machine learning algorithms to make more accurate predictions could also be leveraged. The utilization of these various models allows for flexibility and adaptability in handling different aspects and complexities of scheduling and rescheduling processes. The choice of a specific model or combination of models can be influenced by the nature of the data, the specific requirements of the scheduling task, the desired level of accuracy, computational resources, and other relevant factors. Therefore, the embodiments encompass a broad array of machine learning techniques, each potentially offering unique advantages for different scenarios in the scheduling and rescheduling of calendar items.

It should be also noted that although the term “reschedule” is prominently used in the context of this disclosure, it should be noted that the embodiments and methods described herein are equally applicable to initial first-time scheduling of calendar items. The principles and algorithms that govern the optimal rescheduling of lapsed or conflicting calendar items can be similarly employed for scheduling new or first-time calendar items. Whether scheduling a meeting for the first time or adjusting the time for an existing appointment, the underlying considerations remain consistent. Factors such as participant availability, room occupancy, resource allocation, priority levels, time constraints, and the interplay with other scheduled or rescheduled items are all integral to both scheduling and rescheduling processes. The training component 604 and model 606, therefore, may be configured to learn and apply scheduling strategies that encompass the full spectrum of calendar management, including the creation of new calendar items, the adjustment of existing ones, and the handling of intricate relationships and dependencies among different items. Thus, the systems and methods described may provide a unified approach to the entire lifecycle of calendar items, enhancing the efficiency, coherence, and user satisfaction in managing scheduling tasks, as contemplated by various embodiments of the present invention.

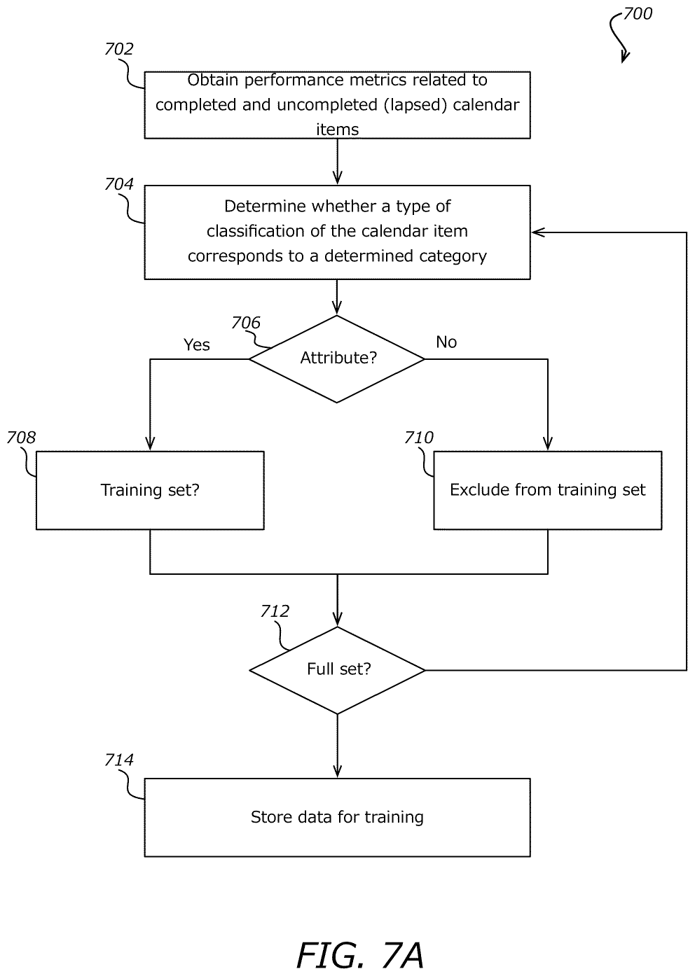

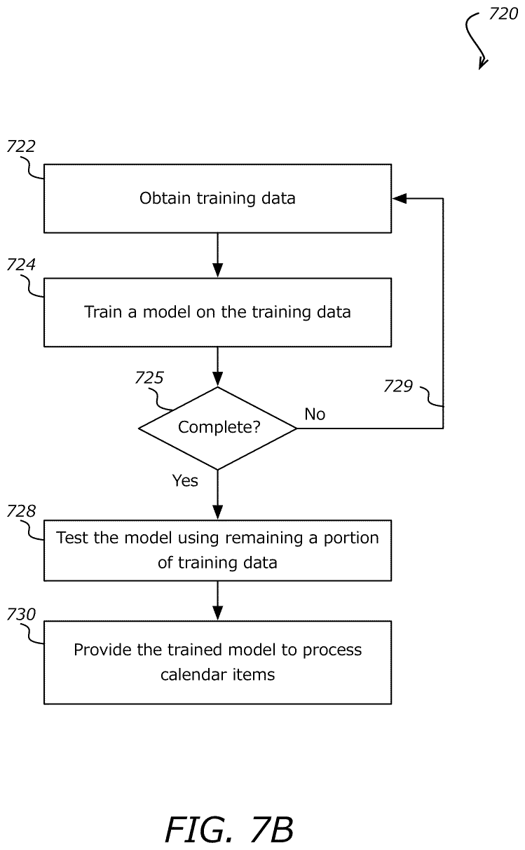

FIG. 7A illustrates an example 700 of a process for determining training data related to scheduling and rescheduling of calendar items that can be utilized in accordance with various embodiments. It should be understood that, for any process discussed herein, there can be additional, fewer, or alternative steps, performed in similar or different orders, or in parallel, within the scope of the various embodiments unless otherwise stated.

In this example, the process begins with obtaining 702 performance metrics related to completed and uncompleted (e.g., lapsed) calendar items for analysis. Additionally, timestamps associated with these calendar items are collected. These timestamps provide information for determining whether a calendar item occurred before, during, or after a selected period and can be used to associate particular categories such as priority level, location considerations, or participant information with the calendar items, enabling an understanding of the temporal patterns and relationships that influence scheduling behaviors. The timestamps can also be used to identify scheduling conflicts, optimize rescheduling, or predict optimal times for specific types of meetings or tasks. The data can be obtained from, for example, historical calendar data, user preferences, priority levels, time constraints, interdependencies among different calendar items, integrations with other systems such as email or project management tools, and other relevant sources as detailed in the training and utilization process of the system.

A timestamp associated with the calendar items (or other information associated with data) can be used to determine 704 whether a type of classification of calendar item corresponds to a category and includes particular attributes, or types of attributes, such as priority level, location considerations, or participant information, for which a model (e.g., neural networks, SVMs, decision trees, etc.) can be trained. This determination may involve pattern recognition and historical analysis, integration with other data, use of machine learning models, rule-based systems, user behavior analysis, and integration with external systems. For example, using a timestamp for calendar items, it can be identified that items scheduled during specific time windows might correlate with certain priority levels or be consistently associated with a particular location or set of participants. In another example, using a timestamp for calendar items can be utilized to analyze cascading rescheduling and conflict resolution. The process may identify the best slots to reschedule lapsed items by considering the temporal relationships between items, thus ensuring the integrity of the overall scheduling system

If it is determined 706 that a calendar item exhibits the attribute (e.g., time, priority, location, etc.) for a particular category, then that calendar item can be added 708 to the training set. The training set can be organized based on various classifications of calendar items, reflecting the associations between timestamps and other attributes like priority or location. For instance, calendar items that typically occur during business hours might be associated with high-priority meetings, while those scheduled during weekends may correlate with personal or low-priority tasks. If the calendar item does not meet the criteria, it can be excluded 710 from the training set. As mentioned elsewhere herein, in at least some embodiments, some of the calendar items may instead be added to a testing set, a holdout set, or not added to any set but may have the attribute classification associated therewith.

If it is determined 712 that a full training set has been obtained, using any appropriate criterion as discussed or suggested herein, such as a threshold number of calendar items for a period of time or sufficient diversity in the temporal patterns and attributes observed, then the training set generation can complete, and the calendar items can be stored 714 for training and other purposes. Otherwise, the process can continue until a full set is obtained, all of the relevant data is analyzed, or another stop condition is satisfied.

FIG. 7B illustrates an example 720 of a process for training a scheduling model that can be utilized in accordance with various embodiments. Once the training data related to scheduling and rescheduling of calendar items is obtained 722, as detailed in FIG. 7A, the training data can be provided as input to a model training process. The training data can include, for example, performance metrics related to completed and uncompleted (e.g., lapsed) calendar items, timestamp records, priority levels, location considerations, participant information, and the like. Thus, according to various embodiments, the training data can include a set of calendar items occurring before, during, or after a selected period, as well as associated attributes like priority or location.

In the example of logistic regression, or other machine learning-based models (e.g., neural networks, SVMs, decision trees), the model can be trained 724 on the training data to predict optimal times for specific types of meetings or tasks or to identify scheduling conflicts and optimize rescheduling. For example, the model can learn various combinations or relations of timestamps to priority levels, locations, participants, etc., such that when calendar items are processed with the trained model, the model can recognize the features and output prediction information, including, for example, the best slots to reschedule lapsed items or potential conflict resolutions, although various other outputs can be utilized as well within the scope of the various embodiments.

If it is determined 725 that a stop condition has been met so that training should be completed, such as by obtaining a full training set as detailed in FIG. 7A or processing the entire training set, then the trained model can be provided to process, for example, scheduling and rescheduling tasks for a particular period of time. As discussed herein, the model might first go through a process to test 728 using at least some of the training classified with the attribute type from earlier steps of the process. If the training is not complete, then the training process can continue 729 until a trained model is obtained. Thereafter, the trained model can be provided 730 to process calendar items associated with a particular period of time to predict scheduling solutions that meet certain criteria, such as optimizing conflicts or aligning with user preferences.

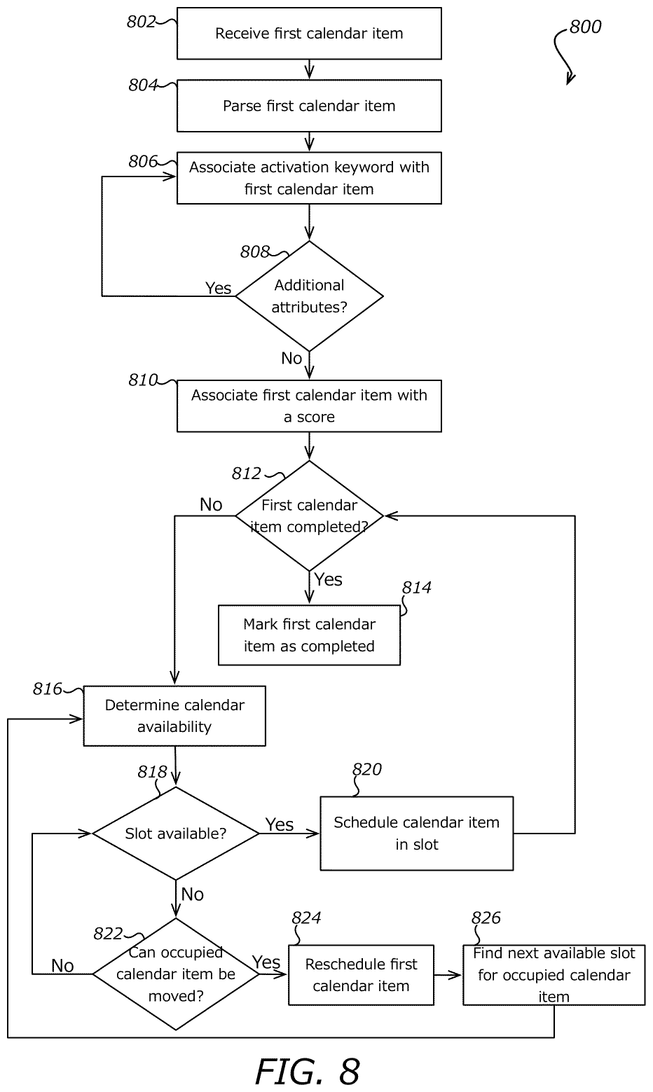

FIG. 8 illustrates an example 800 of a process for event scheduling in accordance with various embodiments. In this example, the process can initiate by receiving 802 a first calendar item. For instance, the first calendar item may be directly received from a user through a dedicated application, such as application 162, thereby enabling a seamless interaction with user-specific scheduling needs. This could include, for example, the user inputting an appointment or task with specific details using a graphical user interface provided by the application. Alternatively, the first calendar item may be retrieved from a remote calendar, such as calendar 164, which could be a part of a larger organizational or shared calendar system. This retrieval may occur, for instance, through an API request, enabling interoperability with various existing calendar platforms. Such an approach could facilitate integration with corporate scheduling systems or cloud-based calendar services, providing a comprehensive scheduling solution. In both cases, whether directly received or retrieved, the first calendar item may contain various properties, such as a description, time, date, location, participants, and other relevant metadata. The ability to receive the calendar item through different channels ensures the adaptability of the system to diverse usage scenarios, ranging from individual task management to complex organizational scheduling. In accordance with various embodiments, the receipt of the first calendar item marks the entry point for the subsequent parsing, associating, and processing steps, and is fundamental in establishing the context and parameters for the following actions. It lays the foundation for the intelligent handling of scheduling, accommodating various user preferences, organizational policies, and real-world constraints, all while maintaining compatibility with diverse calendar systems and user interfaces.

In accordance with various embodiments, the process can execute a parsing step 804 to detect a primary attribute, such as an activation keyword, within the metadata of the previously received calendar item. The parsing function is technically implemented to scan and interpret specific components within the calendar item's structure to identify relevant information that serves as triggers or markers for subsequent actions. For instance, the activation keyword may be a particular term or code embedded within the calendar item's description, title, other fields, or metadata fields. This activation keyword can act as a unique identifier or a categorization mechanism, linking the calendar item to specific rules, actions, or workflows within the system. By detecting the activation keyword, the system may automatically associate the calendar item with particular scheduling logic, constraints, or preferences. This may include, for example, associating a meeting tagged with a “critical” keyword with higher scheduling priority or linking a “remote” keyword to location-specific rules. The parsing operation may be carried out through various algorithms and techniques that are optimized to process different calendar formats, including but not limited to iCalendar, Microsoft Outlook, or Google Calendar formats. By identifying and extracting the primary attribute, the system facilitates intelligent decision-making, ensuring that the calendar item is handled in alignment with user-defined or system-defined criteria. Moreover, this parsing functionality seamlessly interacts with other components described in the application, such as the scoring system based on additional attributes or the rescheduling mechanism. The detection of the primary attribute initiates a chain of processes that collectively contribute to the system's ability to manage and optimize scheduling tasks.

In various embodiments, the process can include a step to associate 806 the activation keyword with the first calendar item, enhancing the system's ability to manage and manipulate the calendar item in a customized and intelligent manner. This association step is technically designed to integrate the activation keyword into specific components of the calendar item's metadata, thereby creating a structured link between the keyword and the calendar entry. For instance, the activation keyword may be embedded into a description property of a VEVENT calendar component, which is part of an iCalendar compatible calendar item. The iCalendar standard, widely recognized and implemented in modern scheduling systems, facilitates the interoperability of calendar data. By embedding the activation keyword in compliance with such standard protocols, the process ensures that the keyword serves its functional purpose without disrupting the compatibility or accessibility of the calendar item across different platforms or devices. In an embodiment, the association of the activation keyword with the calendar item allows for the targeted application of rules, constraints, or behaviors to that specific item. It can enable the system to recognize and respond to the item in a way that aligns with user-defined or system-defined scheduling logic. For example, a “confidential” keyword may trigger specific privacy measures, while a “recurring” keyword might invoke rules related to repetitive scheduling. In various embodiments, this association functionality can also interact dynamically with other parts of the system described herein. It builds upon the parsing functionality of detecting the activation keyword and leads to further processes, such as scoring based on additional attributes or optimization of scheduling. Additionally, the activation keyword with the first calendar item facilitates transforming raw calendar data into actionable intelligence, enriching the scheduling process with added depth, flexibility, and precision. Moreover, the method of associating the activation keyword can be further adapted to different contexts, user roles, or organizational requirements, thereby offering wide-ranging applications. Whether applied in personal scheduling or enterprise-level resource management, the association of keywords opens up possibilities for a more responsive, automated, and context-aware scheduling experience.

In an embodiment, the process proceeds to parse the first calendar item to detect additional attributes, such as priority, deadline, etc. Upon the detection of additional attributes, a decision-making step 808 is employed to ascertain whether these attributes are present and relevant to the scheduling process. If additional attributes are detected, the process may proceed to associate 806 these with the first calendar item. This association may be accomplished, for example, through a technical process that sends an API request to a specific calendar system, such as calendar 164. The API request might be constructed in accordance with specific protocols to embed the additional attribute in a description property or summary property of the VEVENT calendar object. This approach ensures a seamless integration of the attributes into the calendar item's structure, adhering to standardized formats such as the iCalendar compatibility. When additional attributes are not detected, or when the detection process is completed, the first calendar item is then associated 810 with a score, which may be referred to as a priority score. The score quantifies the calendar item's importance, urgency, or relevance based on its inherent attributes. The scoring process might leverage algorithms, heuristics, or user preferences to derive a value that guides subsequent scheduling, rescheduling, or conflict resolution.

A determination is made 812 whether the first calendar item has been completed. Completion of a calendar item may be established based on several factors, such as whether the user has performed the calendar item within the constraints of its associated attributes or within a predetermined timeframe. For example, a meeting marked with a “critical” keyword might be required to be concluded by the end of the current business day. If the first calendar item is determined to be completed, it is marked 814 as such. The technical implementation may involve removing the activation keyword from its metadata, rendering the item as finalized within the system. This completion status may be reflected across various platforms and devices, ensuring consistent tracking and synchronization of user activities. Subsequently, the system will cease monitoring the progress of the calendar item, thereby conserving resources and maintaining system efficiency. This step serves to distinguish between active and completed tasks, enabling prioritization and focus on current or upcoming scheduling needs. It contributes to a streamlined scheduling process that adapts to real-time developments, automatically updating statuses and releasing resources as tasks are completed.

If the first calendar item remains uncompleted, the process determines 816 an appropriate type of time slot for rescheduling the first calendar item. For instance, the calendar item's attributes might contain constraints such as timeboxing, which restricts the item to specific days or times. In the case of a constraint that limits the item to being performed on Thursdays, the process will scan the integrated calendar for any available future time slots that align with this requirement. The scanning may involve algorithms or heuristic approaches to identify slots that meet the given criteria, interacting with the underlying database and user preferences. Furthermore, a determination is made 818 regarding the availability of these time slots. This step exemplifies the system's capability to dynamically adapt to user-specific requirements and constraints, ensuring that rescheduling aligns with individual preferences, organizational rules, or other contextual factors.

In scenarios where a new time slot is found to be available, the first calendar item is rescheduled 820 into that time slot. The process employs rescheduling logic that accounts for existing occupancies and attributes. For example, if the desired time slot is suitable but currently occupied by a second calendar item, an evaluation is conducted to determine 822 whether the second item can be rescheduled. If rescheduling is feasible, the first calendar item is moved 824 into the second calendar item's slot, and the process determines 826 the next available time slot for the second calendar item that complies with its attributes. This determination is made by reapplying the criteria and constraints that were used in step 818 to find suitable time slots, considering factors such as timeboxing restrictions, user preferences, organizational rules, or other relevant attributes. By adhering to these parameters, the system ensures that the second calendar item is placed in an appropriate time slot without violating the original scheduling criteria or user-defined requirements, thus maintaining coherence and efficiency within the overall scheduling process.

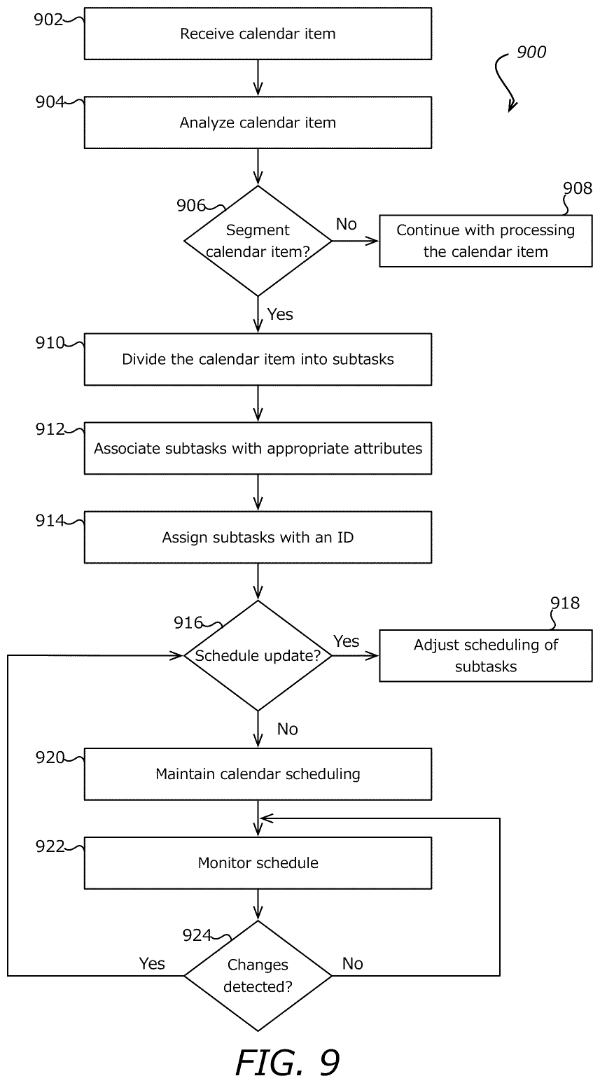

FIG. 9 illustrates an example 900 of a process for segmenting a task in accordance with various embodiments. In this example, a calendar item is received 902. As described, the calendar item may be directly received from a user through a dedicated application, such as application 162, retrieved from a remote calendar, such as calendar 164, which could be a part of a larger organizational or shared calendar system, etc.

The received calendar item is then analyzed 904 to determine its various characteristics, such as duration, complexity, priority level, etc. For example, the system may consider a multi-week project with a high priority level as being more complex due to requirements for specialized resources, intricate scheduling coordination, or strict deadlines. The system assesses the calendar item's characteristics using algorithms, heuristic methods, or customized rulesets, factoring in user-defined criteria, organizational policies, historical data, or predictive insights based on similar past calendar items. This analysis serves as a basis for translating the system's understanding of the item into actionable insights, potentially leading to the division into subtasks.

A determination is made 906 as to whether the calendar item's complexity or duration satisfies a threshold, such as a specific number of hours or other complexity metrics. In an embodiment, the threshold may be defined based on various factors, including but not limited to user preferences, organizational policies, industry standards, or system-defined rules. It may also be dynamically adjusted based on real-time factors, such as available resources, overall workload, upcoming deadlines, or other situational considerations. The threshold serves as a quantitative or qualitative benchmark that guides the decision-making process. For instance, a calendar item representing a multi-day project might be considered for division into subtasks if its duration surpasses a 3-hour threshold. Alternatively, a complex task requiring specialized skills or coordination might meet the threshold based on its inherent complexity, regardless of its duration. The determination of whether the threshold is met may involve algorithms, heuristic methods, or artificial intelligence techniques that evaluate the calendar item in the context of the defined criteria. This decision-making step integrates with other components of the system, such as subtask engine 412, ensuring a cohesive and intelligent approach to task segmentation.

In the scenario where the calendar item does not meet the threshold, the process may continue 908 with other actions related to scheduling, monitoring, or managing the calendar item as a singular entity.

If the threshold is met, the process may proceed to further actions, such as division into subtasks, scheduling, rescheduling, or other processing based on scheduling availability, preferences, constraints, or rules. In a specific example, the calendar item is divided 910 into subtasks. These subtasks are formulated by applying algorithms or optimization methods based on user preferences, project requirements, or system-defined rules. For example, if the predetermined threshold is met, as described in the determination step, the system proceeds to divide the calendar item into one or more subtasks. This division is a tailored operation that considers the unique attributes and requirements of the calendar item. Various factors, such as the nature of the task, the desired granularity of subtasks, the scheduling constraints, and other relevant conditions, may influence how the division is performed. In an embodiment, the formulation of the subtasks may be performed through the application of specific algorithms, optimization methods, heuristic techniques, or a combination thereof. These methods can be designed to ensure an optimal division of the calendar item into subtasks that align with user preferences, project requirements, organizational policies, or system-defined rules. For instance, the division may consider the need to distribute the workload evenly across a time period, to align subtasks with available resources, to meet specific deadlines, or to adhere to other constraints or preferences. In various embodiments, integration with other components within the scheduling system, such as subtask engine 412, delegator engine 314, or calendar connector component 410, may further refine the division process. In one embodiment, the division may result in a set of subtasks of equal duration, such as twenty 2-hour subtasks for a 40-hour project. In another embodiment, the division may be more nuanced, taking into account various dependencies, skill requirements, collaboration needs, or other specific factors, leading to subtasks of varying duration, complexity, or priority.

Following the division of the calendar item into individual subtasks, the system proceeds to associate 912 each subtask with the appropriate attributes inherited from the parent calendar item. This association serves to maintain the integrity, relevance, and coherence of the subtasks with respect to the overall objectives, constraints, and characteristics of the original calendar item. In one embodiment, this association may include the assignment of specific attributes such as priority level, activation keywords, deadlines, third-party participant details, or other parameters that were defined for the parent calendar item. Such attributes could govern the execution, scheduling, reporting, or other aspects of the subtasks. In another embodiment, the association process may involve more complex mapping or transformation, adapting the attributes of the parent calendar item to the unique context of each subtask. For example, a high-level priority assigned to the parent calendar item may be translated into specific scheduling preferences, deadlines, or resource allocations for the individual subtasks. Integration with other components, such as subtask engine 412, may further enhance the association process, ensuring a seamless alignment of subtasks with system-wide rules, user preferences, or organizational policies. This could include, for instance, the automatic synchronization of subtask attributes with external systems, real-time updates, or collaborative work on subtasks facilitated through subtask engine 412. The association process also involves the maintenance of relationships and dependencies between subtasks, reflecting the hierarchical or networked structure of the original calendar item. This may include the creation of links, dependencies, sequencing rules, or other relational structures that define how the subtasks interact with each other and with the overall project or task.

Each subtask may be assigned 914 a unique identifier (ID) or hash value. In an embodiment, the unique identifier facilitates management and tracking of each subtask across various stages, statuses, and operations. It ensures that the subtask can be located, referenced, and manipulated within the system, even when intermingled with a multitude of other tasks and subtasks. In some embodiments, the unique identifier is utilized to construct and maintain relationships between different subtasks or between subtasks and parent tasks. This can include defining dependencies, prerequisites, successors, or other types of relational constructs that reflect the logical or temporal relationships among tasks. By using unique identifiers, these relationships can be accurately represented and managed, preserving the integrity of task hierarchies and flows. The unique identifier may also enable the system to model and manage dependencies that each subtask may have on resources, other subtasks, or external conditions. This ensures that the sequencing, scheduling, and execution of subtasks take into account the requisite dependencies, thereby optimizing the workflow and reducing conflicts or resource contention. In an embodiment, through the unique identifier, the system can associate custom attributes specific to each subtask, reflecting unique characteristics, requirements, or constraints. These custom attributes may be defined by users, inferred from parent tasks, or derived from system rules, and can influence various aspects of subtask handling, such as prioritization, resource allocation, or notification triggers. The assignment of unique identifiers may also interact with other components within the system, such as the subtask engine 412 or comprehensive subtask registry described elsewhere in this application. This interaction ensures that the unique identifiers are leveraged across the system, enabling integrative functions such as global search, cross-module coordination, or compliance with overarching policies and rules.

A determination is made 916 whether changes in the user's schedule, projects, or other relevant parameters that may affect the user's schedule occur.

In the situation it is determined changes occurred, the system dynamically adjusts 918 subtasks by rescheduling, reassigning, or modifying them. For example, when changes occur in the user's schedule or other time-sensitive parameters, the system has the capability to reschedule subtasks. Rescheduling may involve altering the start and end times as described herein. This process can be governed by algorithms that consider various constraints such as dependencies between subtasks, resource availability, and user preferences, ensuring that rescheduling aligns with the overall project timeline and objectives. In another example, the system also enables reassignment of subtasks to different participants, teams, or resources. This reassignment can be triggered by changes in personnel availability, shifts in roles or responsibilities, or alterations in project scope. In yet another example, the system may modify other attributes or parameters of the subtasks. Such modifications might include changes in priority, complexity, or associated activation keywords, as well as adjustments to relationships, dependencies, or custom attributes.

In the situation it is determined to have not occurred, the system proceeds to maintain 920 the existing scheduling, attributes, and relationships of the subtasks. This maintenance ensures that the subtasks continue to align with the originally defined project requirements, constraints, and timeline.

The system then initiates a monitoring 922 process to continually observe for changes in the user's schedule, project requirements, or other relevant parameters that may affect the subtasks. This monitoring may include periodic scans, real-time tracking, or integration with other system components to detect any alterations or updates.

A determination is made 924 whether changes are detected. If changes are detected during the monitoring, the process may loop back to step 916 to dynamically adjust the subtasks by rescheduling, reassigning, or modifying them in response to the observed changes. If no changes are detected, the monitoring process continues, preserving the integrity and coherence of the overall task or project until completion or until changes are detected.

In some embodiments, the subtask engine 412 or other appropriate component is configured to perform additional operations to further organize and manage the subtasks within the system. A specific function entails the population of a comprehensive subtask registry or database with the relevant details of each subtask. This subtask registry serves as a central repository and provides a structured mechanism for managing subtasks across the system. The details incorporated into the registry encompass various aspects of the subtasks. In an example, each subtask's scheduled start and end times are recorded within the registry. This information can be used for managing the chronological sequence of subtasks, aligning with the broader project timeline, and ensuring timely execution. The start and end times may also interact with other scheduling components or algorithms to enable optimal task distribution and resource utilization. In another example, the registry includes information regarding any third-party participants assigned to the subtasks, such as external collaborators, vendors, or other stakeholders. This information facilitates collaboration, communication, and coordination with external entities, ensuring alignment with project goals and compliance with contractual or operational obligations. In yet another example, the current status of each subtask, such as pending, in-progress, completed, or other definable states, is maintained within the registry. This status information enables real-time monitoring, reporting, and control of subtasks, supporting decision-making, prioritization, and adaptive adjustments as the project progresses. Certain embodiments include the provision for associating activation keywords with each subtask. These keywords may be used to trigger specific actions, notifications, or workflows related to the subtask. The utilization of activation keywords provides a flexible mechanism for defining custom behaviors, automations, or integrations, tailoring the system's response to specific scenarios or user needs. The subtask registry's interaction with other components, such as the unique identifiers, ensures a cohesive and integrated approach to subtask management. This interaction supports cross-referencing, data consistency, and seamless navigation between different parts of the system. The subtask registry may further include additional details derived from other sections of this patent application or specific to certain use cases or configurations. This flexibility in the structure of the registry allows the system to adapt to diverse requirements, constraints, or contexts, preserving the scalability and versatility of the solution.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), on a network interface card, or as an application built on Cloud-based services.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

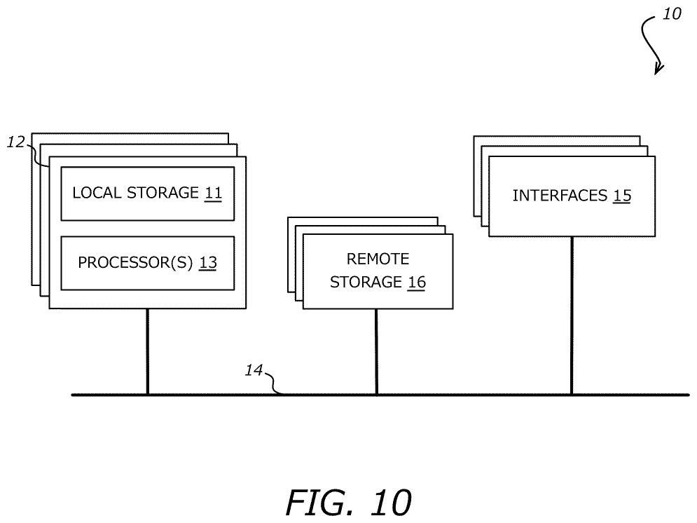

Referring now to FIG. 10, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 10 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations described herein). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a JAVA virtual machine or equivalent, or files containing higher level code that may be executed by the computer using an interpreter (for example, scripts written in Python, Perl, Ruby, Groovy, or any other scripting language).

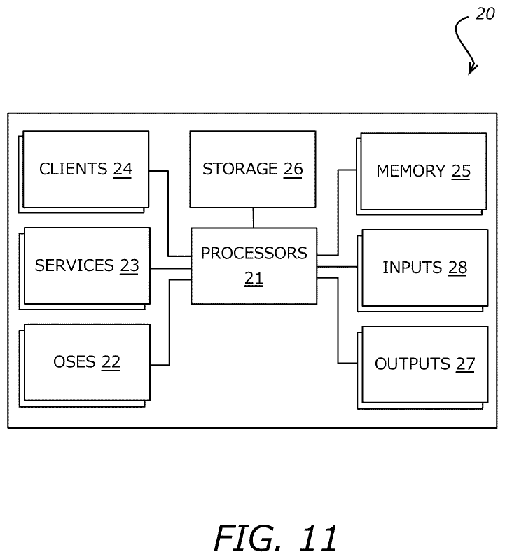

In some embodiments, systems may be implemented on a standalone computing system. Referring now to FIG. 11, there is shown a block diagram depicting a typical exemplary architecture of one or more embodiments or components thereof on a standalone computing system. Computing device 20 includes processors 21 that may run software that carry out one or more functions or applications of embodiments, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described herein, referring to FIG. 10). Examples of storage devices 26 include flash memory, magnetic hard drive, CD-ROM, and/or the like.

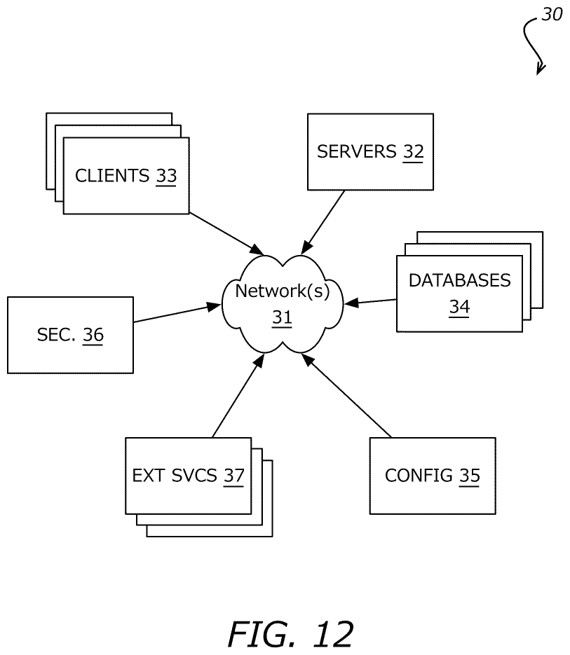

In some embodiments, systems may be implemented on a distributed computing network, such as one having any number of clients and/or servers. Referring now to FIG. 12, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 11. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CAS SANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

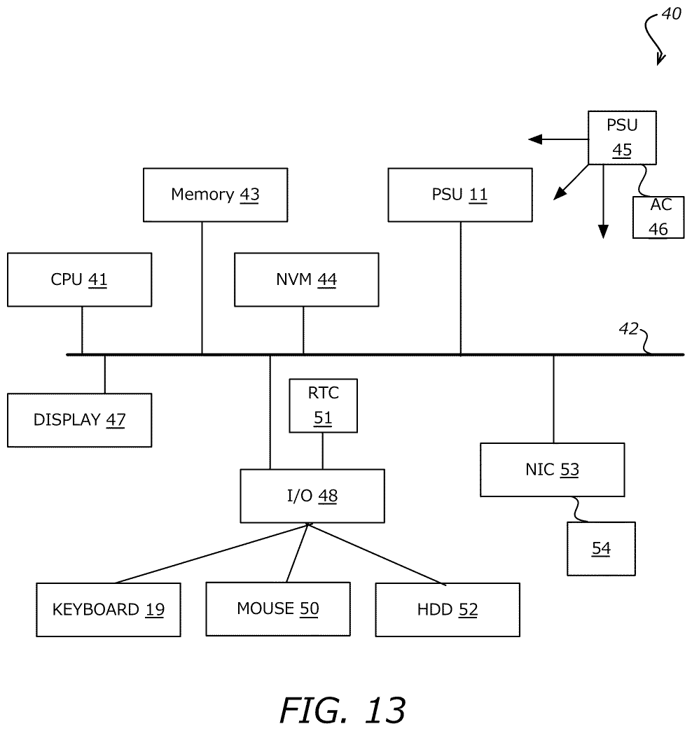

FIG. 13 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described herein. Accordingly, the present invention is defined by the claims and their equivalents.

### Additional Considerations

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating an interactive message through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A computing system for scheduling calendar items associated with a digital calendaring system, comprising:
a computing device processor; and
a memory device including instructions that, when executed by the computing device processor, enables the computing system to:
receive a calendar item associated with a user account, wherein the calendar item represents one of a scheduled task, event, or appointment within the digital calendaring system;
analyze the calendar item to identify an activation attribute, the calendar item including metadata corresponding to the activation attribute, wherein the activation attribute imposes a constraint on a manner of completion of the calendar item;
assign the calendar item into a first calendar slot, wherein the first calendar slot represents a predefined time period for completion of the calendar item within the digital calendaring system;
determine whether the calendar item was completed within the first calendar slot;
determine a second calendar slot when the calendar item is uncompleted, the second calendar slot being temporally posterior to the first calendar slot; and
assign the calendar item to the second calendar slot.

2. The computing system of claim 1, wherein the first calendar slot and second calendar slot are temporally compatible with the activation attribute, and wherein being temporally compatible with the activation attribute comprises a timing of the first calendar slot and the second calendar slot satisfying at least one constraint specified by the activation attribute related to scheduling of the calendar item.

3. The computing system of claim 1, further comprising:
determine a third calendar slot when a second calendar item occupies the second calendar slot;
assign the second calendar item to the third calendar slot; and
assign the calendar item to the second calendar slot, wherein the assignments occur at substantially a same time.

4. The computing system of claim 1, wherein the activation attribute imposes constraints on the calendar item selected from a group consisting of temporal constraints, priority constraints, and geographical constraints, wherein the temporal constraints include at least one of a deadline, start date, timebox, and recurrence, and the priority constraints include a priority score.

5. The computing system of claim 1, wherein the instructions, when executed by the computing device processor, further enables the computing system to:
assign a countdown to the calendar item when the activation attribute is a deadline, the countdown indicating a remaining time to the deadline.

6. The computing system of claim 5, wherein the instructions, when executed by the computing device processor, further enable the computing system to:
detect a rescheduling of the calendar item into the second calendar slot to a rescheduled time;
calculate an updated countdown corresponding to the remaining time to the deadline for completion of the calendar item based on the rescheduled time; and
incorporate the updated countdown into a title of the calendar item within the digital calendaring system, wherein the countdown in the title is configured to be automatically adjusted to reflect changes in the remaining time to the deadline, such that the countdown continuously displays an accurate measure of the time remaining until the deadline.

7. The computing system of claim 1, wherein the instructions, when executed by the computing device processor, further enable the computing system to:
track a time of completion of the calendar item when completed within a calendar slot; and
store the tracked time of completion.

8. The computing system of claim 1, wherein the calendar item is received via a calendaring system, the calendaring system being associated with a user account and configured to manage, store, and organize calendar items.

9. The computing system of claim 1, wherein the instructions, when executed by the computing device processor to analyze the calendar item, further enables the computing system to:
parse the calendar item to detect the activation attribute within the metadata of the calendar item, wherein parsing the calendar item comprises scanning and interpreting components associated with a structure of the calendar item to identify the activation attribute as a unique identifier linking the calendar item to a set of scheduling guidelines.

10. The computing system of claim 1, wherein the instructions, when executed by the computing device processor to assign the calendar item into the first calendar slot, further enables the computing system to:
select a time period in the digital calendaring system, said time period corresponding to the predefined time period for completion of the calendar item, and associating the calendar item with the selected time period.

11. The computing system of claim 1, wherein the instructions, when executed by the computing device processor to determine the second calendar slot for the uncompleted calendar item, further enables the computing system to:
identify a subsequent available time period in the digital calendaring system that is temporally posterior to the first calendar slot, and designating said subsequent available time period as the second calendar slot for the uncompleted calendar item.

12. The computing system of claim 1, wherein a graphical user interface component enables a user to create the calendar item by at least one of inputting a description, assigning an activation keyword, or specifying additional attributes comprising at least one of duration, deadline, priority level, time range, recurrence, and accompanying notes.

13. The computing system of claim 1, wherein the instructions, when executed by the computing device processor, further enables the computing system to:
compare a duration of an amount of time allotted to the calendar item to a time-based threshold;
determine the duration satisfies the time-based threshold; and
divide the calendar item into at least two subtasks.

14. A computer-implemented method, comprising:
receiving a calendar item associated with a user account, wherein the calendar item represents one of a scheduled task, event, or appointment within a digital calendaring system;
analyzing the calendar item to identify an activation attribute, the calendar item including metadata corresponding to the activation attribute, wherein the activation attribute imposes a constraint on a manner of completion of the calendar item;
assigning the calendar item into a first calendar slot, wherein the first calendar slot represents a predefined time period for completion of the calendar item within the digital calendaring system;
determining whether the calendar item was completed within the first calendar slot;
determining a second calendar slot when the calendar item is uncompleted, the second calendar slot being temporally posterior to the first calendar slot; and
assigning the calendar item to the second calendar slot.

15. The computer-implemented method of claim 14, further comprising:
determining a third calendar slot when a second calendar item occupies the second calendar slot;
assigning the second calendar item to the third calendar slot; and
assigning the calendar item to the second calendar slot, wherein the assignments occur at substantially a same time.

16. The computer-implemented method of claim 14, further comprising:
assigning a countdown to the calendar item when the activation attribute is a deadline, the countdown indicating a remaining time to the deadline.

17. The computer-implemented method of claim 16, further comprising:
detecting a rescheduling of the calendar item into the second calendar slot;
calculating an updated countdown corresponding to the remaining time to the deadline for completion of the calendar item based on a rescheduled time; and
incorporating the updated countdown into a title of the calendar item within the digital calendaring system, wherein the countdown in the title is configured to be automatically adjusted in real time to reflect changes in the remaining time to the deadline, such that the countdown continuously displays an accurate measure of a time remaining until the deadline.

18. The computer-implemented method of claim 14, further comprising:
parsing the calendar item to detect an activation attribute within the metadata of the calendar item, wherein parsing the calendar item comprises scanning and interpreting components associated with a structure of the calendar item to identify the activation attribute as a unique identifier linking the calendar item to a set of scheduling guidelines.

19. The computer-implemented method of claim 14, further comprising:
comparing a duration of an amount of time allotted to the calendar item to a time-based threshold;
determining the duration satisfies the time-based threshold; and
dividing the calendar item into at least two subtasks.

20. A non-transitory computer readable storage medium storing instructions that, when executed by at least one processor of a computing system, causes the computing system to:
receive a calendar item associated with a user account, wherein the calendar item represents one of a scheduled task, event, or appointment within a digital calendaring system;
analyze the calendar item to identify an activation attribute, the calendar item including metadata corresponding to the activation attribute, wherein the activation attribute imposes a constraint on a manner of completion of the calendar item;
assign the calendar item into a first calendar slot, wherein the first calendar slot represents a predefined time period for completion of the calendar item within the digital calendaring system;
determine whether the calendar item was completed within the first calendar slot;
determine a second calendar slot when the calendar item is uncompleted, the second calendar slot being temporally posterior to the first calendar slot; and
assign the calendar item to the second calendar slot.
